(19) United States
(12) Patent Application Publication
(10) Pub. No.: US 2019/0343139 A1
(43) Pub. Date: Nov. 14, 2019

(54) PROCESSING HUMAN MILK FOR GENERATING COMPOSITIONS OF FORTIFIED HUMAN MILK PRODUCTS

(71) Applicant: IMB INC., Port St. Lucie, FL (US)

(72) Inventors: Glenn W SNOW, Incline Village, NV (US); Laura SALTER, Incline Village, NV (US)

(73) Assignee: IMB Inc., Port St. Lucie, FL (US)

(21) Appl. No.: 16/474,442

(22) PCT Filed: Dec. 27, 2017
(86) PCT No.: PCT/US2017/068481

§ 371 Date: Jun. 27, 2019

Related U.S. Application Data
(63) Continuation of application No. 15/723,936, filed on Oct. 3, 2017.
(60) Provisional application No. 62/486,884, filed on Apr. 18, 2017.
(60) Provisional application No. 62/439,408, filed on Dec. 27, 2016.

(51) Int. Cl. A23C 9/20; A23L 3/16; A23C 3/033

(52) U.S. Cl. CPC A23C 9/206; A23L 3/16; A23V 2002/00; A23C 2210/256; A23C 3/033

(57) ABSTRACT

Systems and methods for generating a processed fortified human milk product from raw human milk, and processed fortified human milk product compositions obtained thereby, are provided. The processed fortified human milk product composition possesses high nutritional content such as high concentrations of protein and human milk oligosaccharides. The processed fortified human milk product composition exhibits low overall bioburden and is non-allogenic and non-immunogenic. When ingested by an individual, the processed fortified human milk product composition achieves high bioavailability and reduces inflammatory processes.

### 1. CROSS REFERENCE TO RELATED APPLICATIONS

This application claims the benefit of U.S. application Ser. No. 15/723,936, filed Oct. 3, 2017, U.S. Provisional Application No. 62/486,884 filed on Apr. 18, 2017, and U.S. Provisional Application No. 62/439,408 filed on Dec. 27, 2016. The content of each of the above referenced applications is incorporated herein by reference in its entirety.

### 2. FIELD OF THE INVENTION

The present invention relates to processed human milk product compositions and methods for generating processed human milk product compositions. More particularly, the present invention relates to fortifying and processing raw human milk obtained from human donors to produce the processed human milk product compositions.

### 3. BACKGROUND

Human breast milk is an excellent source of nutrition for neonates. However, human milk is in short supply—in the US alone, there is currently an annual unmet demand by neonatal intensive care units for 60-80 million additional ounces. Human breast milk has further been proposed for remote consumption by adolescents and adults such as for therapeutic support in patients with cancer, neurodegenerative diseases, and various wasting diseases. This adds to the demand for human breast milk with higher nutritional value, in comparison to raw human breast milk.

Current methods of processing human milk for remote consumption typically include at least one concentration step to increase protein concentration. This requirement for concentration further reduces the supply of processed milk. There is, therefore, a need for methods that reduce or eliminate the need for fluid concentration during human milk processing while ensuring final desired protein concentration.

Even without regard to supply, there is a need for human milk compositions with supplemented nutrients such that the human milk composition is non-immunogenic, non-allergenic, non-inflammatory, and has high bioavailability of the nutrients when consumed by individuals such as neonates, adolescents, or adults.

### 4. SUMMARY

The present disclosure provides a human milk composition that can be produced through a processing and fortification process. In various embodiments, the human milk composition, hereafter referred to as a processed fortified human milk product, has, per 100 g of the product: (a) 80 to 120 calories, (b) 3.0 g to 5.0 g of total fat, (c) 1.1 g to 2.3 g of saturated fat, (d) 14 mg to 22 mg of cholesterol, (e) 17 mg to 26 mg of sodium, (f) 3 g to 13 g of carbohydrates, (g) 2 g to 9 g of sugar, (h) 99 mg to 121 mg of calcium, and (i) 5.9 to 9.1 g of protein. In various embodiments, the protein of the product includes, per 100 g of the product: (a) 0.1 g to 0.2 g of alanine, (b) 0.08 g to 0.2 g of arginine, (c) 0.26 to 0.38 g of aspartic acid, (d) 0.04 to 0.12 g of cysteine, (e) 0.60 to 0.70 g of glutamic acid, (f) 0.05 g to 0.15 g of glycine, (g) 0.13 g to 0.23 g of histidine, (h) 0.75 g to 0.90 g of isoleucine, (i) 1.20 g to 1.35 g of leucine, (j) 0.70 g to 0.85 g of lysine, (k) 0.35 to 0.45 g of methionine, (l) 0.25 g to 0.40 g of proline, (m) 0.20 g to 0.35 g of serine, (,) 0.64 to 0.80 g of threonine, (o) 0.10 g to 0.25 g of tryptophan, (p) 0.10 g to 0.25 g of tyrosine, and (q) 0.90 g to 1.05 g of valine.

In various embodiments, the processed fortified human milk product has a protein digestibility corrected amino acid score greater than 65%. In various embodiments, the processed fortified human milk product has an amino acid score greater than 0.70.

In various embodiments, the processed fortified human milk product further includes a concentration of human milk oligosaccharides between 6 grams per liter and 24 grams per liter of the processed fortified human milk product. In various embodiments, the processed fortified human milk product further includes a concentration of fucosylated human milk oligosaccharides between 6.0 grams per liter and 8.0 grams per liter of the processed fortified human milk product. In various embodiments, the processed fortified human milk product further includes a concentration of 2′-fucosyllactose between 0.70 grams per liter and 4.3 grams per liter of the processed fortified human milk product. In various embodiments, the processed fortified human milk product further includes a concentration of 3′-fucosyllactose between 0.92 grams per liter and 1.1 grams per liter of the processed fortified human milk product. In various embodiments, the processed fortified human milk product further includes a concentration of sialylated human milk oligosaccharides between 1.80 grams per liter and 1.90 grams per liter of the processed fortified human milk product. In various embodiments, the processed fortified human milk product further includes a concentration of non-fucosylated human milk oligosaccharides between 4.50 grams per liter and 4.75 grams per liter of the processed fortified human milk product.

In various embodiments, the processed fortified human milk product includes a bacterial aerobic plate count of less than 10 CFUs per gram of the processed fortified human milk product. In various embodiments, the processed fortified human milk product includes a yeast count of less than 10 CFUs per gram of the processed fortified human milk product. In various embodiments, the processed fortified human milk product includes a mold count of less than 10 CFUs per gram of the processed fortified human milk product. In various embodiments, the processed fortified human milk product further includes a presumptive Bacillus Cereus count of less than 100 CFUs per gram of the processed fortified human milk product.

In various embodiments, the processed fortified human milk product is packaged in an aseptically packaged product. In various embodiments, the processed fortified human milk product packaged in one of a bottle, booster cup, paper carton, paper brick, or a pouch.

The processed fortified human milk product is generated using a processing process. In various embodiments, the processed fortified human milk product is processed using a low temperature long time pasteurization technique which comprises heating a fortified human milk sample to a target temperature of at least 62° C. and holding the fortified human milk sample at the target temperature for not less than 30 minutes. In various embodiments, the processed fortified human milk product is processed using a high temperature short time pasteurization technique which comprises heating a fortified human milk sample to a target temperature of at least 72° C. and holding the fortified human milk sample at the target temperature for not less than 15 seconds. In various embodiments, the processed fortified human milk product is processed using a retort processing technique which comprises heating a fortified human milk sample to a target temperature between 110° C. and 130° C. and holding the fortified human milk sample at the target temperature between 10 minutes to 30 minutes. In various embodiments, the processed fortified human milk product is processed using a thermization technique which comprises heating a fortified human milk sample to a target temperature between 63° C. and 65° C. and holding the fortified human milk sample at the target temperature for not less than 15 seconds. In various embodiments, the processed fortified human milk product is processed using an irradiation treatment which comprises applying an ionizing radiation selected from one of gamma rays, x-rays, or electron beams. In various embodiments, the ionizing radiation is provided at a dose of 1 to 70 kilograys for a duration of time between 1 second and 45 minutes. In various embodiments, the processed fortified human milk product is processed using a microwave treatment which comprises applying microwaves to heat a fortified human milk sample to a target temperature between 70° C. and 130° C. for a pre-designated amount of time between 1 and 20 minutes. In various embodiments, the microwaves are applied at a frequency between one of 900 and 1000 MHz or 2100 and 2600 MHz.

In various embodiments, the processed fortified human milk product is processed using an ultra-high temperature sterilization technique which comprises heating a fortified human milk sample to a target temperature between 130° C. and 150° C. and holding the fortified human milk sample at the target temperature for 3 to 15 seconds. In various embodiments, heating the fortified human milk sample to a target temperature between 130° C. and 150° C. comprises providing heated steam into the fortified human milk sample. In various embodiments, heating the fortified human milk sample to a target temperature between 130° C. and 150° C. comprises performing a counter-current heat exchange between the fortified human milk sample and a heating medium.

Further disclosed herein are methods for producing a processed fortified human milk product. In various embodiments, the method comprises the steps of: receiving raw human milk obtained from one or more human donors; fortifying the raw human milk with supplemental nutrients to achieve one of a target characteristic of the fortified raw human milk or a target concentration of a component in the fortified raw human milk; and processing the fortified raw human milk by treating the fortified raw human milk to eliminate pathogens from the fortified raw human milk.

In various embodiments, processing the fortified raw human milk comprises performing an ultra-high temperature sterilization process on the fortified raw human milk, wherein treating the fortified raw human milk comprises raising a temperature of the fortified raw human milk to a target temperature between 130° C. and 150° C. and holding the fortified raw human milk for a hold time between 6 and 14 seconds. In various embodiments, processing the fortified raw human milk comprises performing a low temperature long time pasteurization process on the fortified raw human milk, wherein treating the fortified raw human milk comprises raising a temperature of the fortified raw human milk to a target temperature between 162° C. and 64.5° C. and holding the fortified raw human milk for a hold time for at least 30 minutes.

In various embodiments, processing the fortified raw human milk comprises performing a high temperature short time pasteurization process on the fortified raw human milk, wherein treating the fortified raw human milk comprises raising a temperature of the fortified raw human milk to a target temperature of at least 71° C. and holding the fortified raw human milk for a hold time for at least 15 seconds. In various embodiments, processing the fortified raw human milk comprises performing a thermization sanitation process on the fortified raw human milk, wherein treating the fortified raw human milk comprises raising a temperature of the fortified raw human milk to a target temperature of at least 63° C. and 65° C. and holding the fortified raw human milk for a hold time for at least 15 seconds.

In various embodiments, processing the fortified raw human milk comprises performing an irradiation treatment on the fortified raw human milk, wherein treating the fortified raw human milk comprises applying an ionizing radiation selected from one of gamma rays, x-rays, or electron beams at a dose of 1 to 70 kilograys for a duration of time between 1 second and 45 minutes. In various embodiments, processing the fortified raw human milk comprises performing a microwave treatment on the fortified raw human milk, wherein treating the fortified raw human milk comprises raising a temperature of the fortified raw human milk to a target temperature of at least 70° C. and 130° C. for a pre-designated amount of time between 1 and 20 minutes. In various embodiments, treating the fortified raw human milk comprises applying microwaves at a frequency between one of 900 and 1000 MHz or 2100 and 2600 MHz.

In various embodiments, processing the fortified raw human milk further comprises: packaging the fortified raw human milk in a retortable container; performing an in-container sterilization process on the packaged fortified raw human milk, wherein the target temperature is between 110° C. and 130° C. and wherein the target hold time is between 10 minutes and 30 minutes.

In various embodiments, the supplemental nutrients used to fortify the raw human milk is one or more of fat, protein, vitamins, cholesterol, ionic salts, carbohydrates, immunoglobulins, and oligosaccharides. In various embodiments, the target characteristic of the fortified raw human milk is one of a density or caloric content.

In various embodiments, prior to fortifying the raw human milk, eliminating pathogens from the raw milk by performing one or more clarification processes to obtain a clarified human milk sample. In various embodiments, after eliminating pathogens through one or more clarification processes and prior to fortifying the raw human milk, the method further comprises the steps of: separating the clarified human milk sample into a cream sample and a skim sample; generating a retentate by performing a concentration process on the skim sample; and engineering a standardized human milk sample by combining a portion of the cream sample with a portion of the obtained retentate.

In various embodiments, the method further comprises a step of, subsequent to processing the fortified raw human milk, packaging, through an aseptic process, the processed fortified human milk to produce the processed fortified human milk product. In various embodiments, the processed fortified human milk is packaged in one of a bottle, booster cup, paper carton, paper brick, or a pouch.

### 5. BRIEF DESCRIPTION OF THE DRAWINGS

The accompanying drawing(s), which are incorporated in and constitute a part of this specification, illustrate several aspects described below.

FIG. 1 depicts a flow process within a system for processing raw human breast milk to generate a processed fortified human milk product, in accordance with an embodiment of the present invention.

FIG. 2 depicts a flow chart for generating a processed fortified human milk product, in accordance with an embodiment of the present invention.

FIG. 3A tabulates parameters from multiple pilot-scale runs of an ultra-high temperature sterilization process described further in Example 7.1, in accordance with embodiments of the present invention.

FIG. 3B presents comparative nutritional data of a raw human milk sample and processed human milk product prepared in accordance with an embodiment of the present invention.

FIG. 3C presents compositional characteristics of a first batch of a raw milk sample and processed human milk products resulting from sterilization Run 4 and Run 11 as defined in FIG. 3A, with the retention of each compositional characteristic calculated relative to the first batch of raw milk product.

FIG. 3D presents compositional characteristics of a second batch of a raw milk sample and the processed human milk products resulting from sterilization Run 7 and Run 14 as defined in FIG. 3A, with the retention of each compositional characteristic calculated relative to the second batch of raw milk product.

FIG. 3E presents quantified bacterial, mold and yeast content for raw human milk, processed human milk product, and pasteurized human milk.

FIGS. 4A and 4B present amounts of various supplements added per liter of milk sample to obtain fortified milk samples.

FIG. 4C depicts the processing parameters used to sterilize each fortified milk sample and B. Cereus log reduction of each fortified milk sample following sterilization.

FIG. 4D presents compositional characteristics of a raw milk sample and sample 13 of the sterilized fortified human milk product which is fortified with nutrients as shown in FIG. 4B.

FIG. 5A depicts analytical data of the composition of processed human milk product and sterilized fortified human milk product processed in Example 7.3.

FIG. 5B depicts analytical protein data of the composition of processed human milk product and sterilized fortified human milk product processed in Example 7.3.

FIG. 5C depicts microbial counts from processed human milk product and sterilized fortified human milk product in comparison to their raw counterparts.

### 6. DETAILED DESCRIPTION

### 6.1. Definitions

It is to be understood that this invention is not limited to the particular embodiments described, as such may, of course, vary. It is also to be understood that the terminology used herein is for the purpose of describing particular embodiments only, and is not intended to be limiting, since the scope of this invention will be limited only by the appended claims.

The detailed description of the invention is divided into various sections only for the reader's convenience, and disclosure found in any section may be combined with that in another section. Unless defined otherwise, all technical and scientific terms used herein have the same meaning as commonly understood by one of ordinary skill in the art to which this invention belongs.

Throughout this disclosure, various aspects of the invention can be presented in a range format. Ranges include the recited endpoints. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Unless specifically stated or apparent from context, as used herein the term “or” is understood to be inclusive.

Unless specifically stated or apparent from context, as used herein, the terms “a”, “an”, and “the” are understood to be singular or plural. That is, the articles “a” and “an” are used herein to refer to one or to more than one (i.e., to at least one) of the grammatical object of the article. By way of example, “an element” means one element or more than one element.

In this disclosure, “comprises,” “comprising,” “containing,” “having,” “includes,” “including,” and linguistic variants thereof have the meaning ascribed to them in U.S. patent law, permitting the presence of additional components beyond those explicitly recited.

Unless specifically stated or otherwise apparent from context, as used herein the term “about” or “approximately” is understood as within a range of normal tolerance in the art, for example within 2 standard deviations of the mean and is meant to encompass variations of ±20% or ±10%, more preferably ±5%, even more preferably ±1%, and still more preferably ±0.1% from the stated value.

The term “raw human milk” or “raw human breast milk” composition is understood to mean human milk obtained from one or more female humans without any form of pasteurization, sanitation, sterilization or decontamination having taken place. The raw composition may have been obtained from one or multiple donors, optionally pooled and optionally contaminated with B. Cereus and other bacterial, viral, mold, spores, or yeast pathogens.

The term “fortified human milk product” composition is understood to mean the milk composition obtained after fortifying human milk with supplemental nutrients such as lipid/fat, protein (amino acids, whey, casein, albumin, enzymes, etc.), vitamins, cholesterol, ionic salts (e.g., sodium, calcium, iron, etc.) carbohydrates, immunoglobulins, and oligosaccharides.

The term “processed human milk product” composition is understood to mean the milk composition obtained after application of a method of milk processing by a milk processor in accordance with various embodiments of the present invention. Examples of milk processing include milk sanitization using one of pasteurization, thermization, irradiation, or microwave. Examples of milk processing also include milk sterilization using one of ultra-high temperature sterilization or in-container sterilization.

The term “processed fortified human milk product” composition is understood to mean the milk composition obtained after both fortifying human milk with supplemental nutrients and processing the human milk.

### 6.2. Systems and Methods for Generating a Processed Fortified Human Milk Product

### 6.2.1. Devices of the Milk Processing System

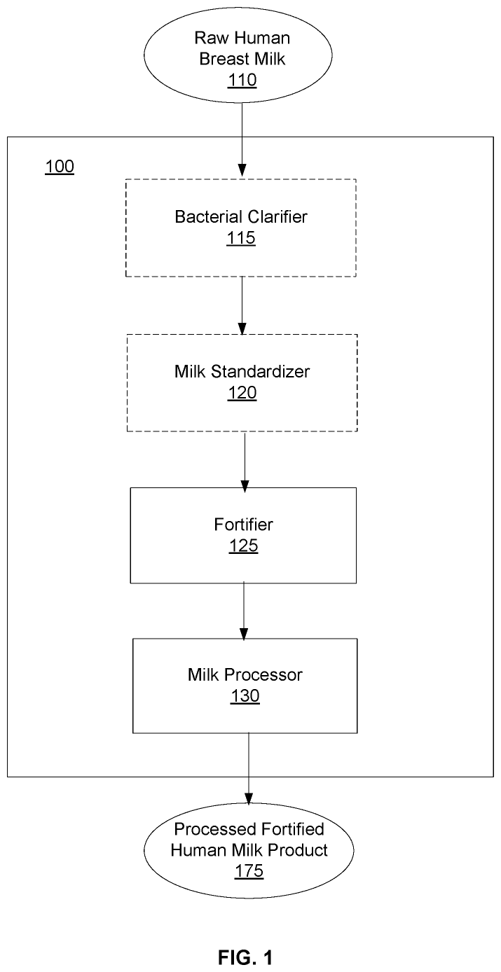

FIG. 1 depicts a flow process for processing raw human breast milk to generate a processed fortified human milk product, in accordance with an embodiment of the present invention.

As depicted in FIG. 1, raw human breast milk 110 is provided to a system 100 that produces the processed fortified human milk product 175. In various embodiments, once the raw human breast milk 110 enters the system 100, the milk is not exposed to the external environment again until it is recovered as a processed fortified human milk product 175.

The system comprises a fortifier 125 and a milk processor 130.

In various embodiments, the closed in-line processing system 100 further includes one or more additional devices, such as those shown in FIG. 1, such as bacterial clarifier (synonymously, milk clarifier) 115 and milk standardizer 120, or additional devices not shown in FIG. 1, such as a milk homogenizer that homogenizes a milk sample or a deaerator that removes gasses from a milk sample.

As an example, in some embodiments, such as those preferred for producing an engineered milk product suitable for remote consumption by premature infants, system 100 includes bacterial clarifier 115 and milk standardizer 120. In certain of these embodiments, system 100 further includes a milk homogenizer and a milk deaerator. In other embodiments, such as those preferred for producing an engineered milk product designed for adult consumption, system 100 includes a milk homogenizer but does not include milk standardizer 120. In certain of these latter embodiments, system 100 further includes bacterial clarifier (milk clarifier) 115. In some embodiments, the devices in the system 100 may be ordered differently. For example, the position of the bacterial clarifier (milk clarifier) 115, milk standardizer 120, and fortifier 125 within the system 100 may be interchanged.

In various embodiments, the devices of the closed in-line processing system 100 are in fluid communication with one another such that a continuous flow processing of the raw human breast milk 110 can occur as it is processed through system 100. As depicted in FIG. 1, for example, the bacterial clarifier (milk clarifier) 115 may be in fluidic communication with the milk standardizer 120, which is in further fluid communication with the fortifier 125, which is further in fluid communication with the milk processor 130. The tubes, pipes, or the like may be connected to the respective devices of the system 100 through welds, threads, or other appropriate connections. In various embodiments, the system 100 includes one inlet (e.g., where the raw human breast milk 110 is inputted) and one outlet (e.g., where the processed fortified human milk product 175 is outputted).

### 6.2.1.1. Raw Human Breast Milk

The system 100 receives a batch of raw human breast milk 110.

In typical embodiments, the batch of raw human breast milk 110 is prepared by pooling a plurality of individual milk donations. In some embodiments, the plurality of milk donations is from a single donor. In typical embodiments, the plurality of milk donations includes milk from a plurality of donors.

In typical embodiments, each donor collects a plurality of raw human milk samples, freezing each sample as soon as fully expressed. The plurality of frozen raw human milk samples is then shipped frozen to be pooled and provided to the system 100 for processing.

Following receipt, the raw human breast milk from each donor is validated, that is, determined to meet certain requirements. In typical embodiments, one or more of an organoleptic test, a clot on boiling test, an alcohol test, an acidity test, a resazurin test, a drug test, and a milk inhibitor test is performed. Typically, raw milk donations that do not pass the validation test are discarded to prevent the donation from contaminating or adulterating a pooled raw human breast milk 110 batch that is to be provided to the system 100.

In various embodiments, prior to being provided to the system 100, the raw human breast milk 110 is sampled to determine characteristics or concentrations of components of the raw human breast milk 110. As used hereafter, characteristics of raw human breast milk 110 (and other milk products described below) include the density of the milk and total calories of the milk. Additionally, components of raw human breast milk 110 (and other milk products described below) include lipid/fat, protein (whey, casein, albumin, etc.), vitamins, cholesterol, ionic salts (e.g., sodium, calcium, iron, etc.) carbohydrates, immunoglobulins, and oligosaccharides. These initial characteristics and/or concentration of components of the raw human breast milk 110 may be provided to the milk combiner 150 for engineering the standardized human milk product. The process of engineering the standardized human milk product is described in further detail below.

In one embodiment, the total volume of a raw human breast milk 110 batch is 1,200 liters. In other embodiments, the total volume of a raw human breast milk 110 batch is more or less than 1,200 liters.

### 6.2.1.2. Bacterial Clarifier (Milk Clarifier)

The bacterial clarifier (also, synonymously, milk clarifier) 115 is a device or apparatus capable of removing a fraction or all of pathogenic material and/or pathogens (e.g., bacterial, mold, spores, and or yeast contaminants) in the raw human breast milk 110. In one embodiment of the present system, the bacterial clarifier 115 is the first device of the system 100 that receives the raw human breast milk 110 and outputs clarified milk to the next device which, in some embodiments, is the milk standardizer 120. In other embodiments, bacterial clarifier 115 outputs clarified milk to fortifier 125. In other embodiments, bacterial clarifier 115 outputs clarified milk directly to milk processor 130.

In some embodiments, bacterial clarifier 115 includes a single bacterial clarifier device 135 which outputs clarified milk for input into the next device in the system 100. In some embodiments, the single bacterial clarifier removes up to 90% of pathogens, such as B. Cereus spores and/or C. Botulinum spores, from the milk.

In some embodiments, bacterial clarifier 115 includes a plurality of bacterial clarifier devices. For example, a first bacterial clarifier removes a first fraction of the pathogens and/or pathogenic material. The milk is then flowed to a second bacterial clarifier which further removes a second fraction of pathogens and/or pathogenic material. In various embodiments, flowing the raw human breast milk 110 through first bacterial clarifier and second bacterial clarifier effects a double bacterial clarification process that removes up to 90% of pathogens from the milk. In some embodiments, the double bacterial clarification process removes up to 90% of B. Cereus spores from the milk. In some embodiments, the double bacterial clarification process removes up to 90% of C. Botulinum spores from the milk. The result of the double bacterial clarification process in these embodiments is clarified milk, which is provided to the next device in the system 100.

In other embodiments, the bacterial clarifier 115 employs more than two bacterial clarifiers in series to further increase the amount of pathogenic clarification.

In various embodiments, each bacterial clarifier 115 is a centrifugal filtration device. An example of a suitable bacterial clarifier 115 is the GEA bacterial separator such as the GEA Pathfinder. In such embodiments, human breast milk that is provided to the bacterial clarifier 115 is centrifuged at a pre-determined speed for a duration of time. As the human breast milk 110 is centrifuged, solids above a particular density are collected according to the centrifugation speed and duration of centrifugation. These solids include larger pathogenic microbes (e.g., bacteria, viruses) as well as donor cells and other cellular material. The solids can then be further discharged at periodic intervals from the bacterial clarifier 115. The clarified human breast milk can then be provided to the next device in the system 100.

### 6.2.1.3. Milk Standardizer

Returning to FIG. 1, a milk standardizer 120 engineers a standardized human milk product to possess a target amount of components (e.g., specific nutrients) and/or target characteristics. Milk standardizer 120 thus ensures that the milk provided for fortification and for processing is standardized, such that each processed fortified human milk product 175 batch that is generated has reduced variability in comparison to another processed fortified human milk product 175 batch.

The milk standardizer may be a device composed of additional devices such as a milk separator, a concentrator, and a milk combiner that generates a standardized milk product that is provided to the next device of the system 100. A milk separator separates a milk sample into a cream fraction and a skim fraction. The cream fraction refers to the portion of the milk sample that includes a mixture of lipids (e.g., fats) whereas the skim fraction includes components such as ionic salts, proteins (e.g., lactose, whey, casein micelles, immunoglobulins, albumin, and the like), water soluble vitamins, and human milk oligosaccharides (HMOs). In various embodiments, the milk separator is capable of holding the temperature of the clarified milk, cream fraction, and skim fraction at a particular temperature. For example, the milk separator may apply refrigeration in order to hold the temperature of the clarified milk and each fraction at around 4° C.-20° C. In other embodiments, the milk separator may apply heating in order to hold the temperature of the clarified milk and each fraction at around 45-65° C. Depending on the temperature at which the milk is to be separated, the milk separator may be designed accordingly given that the viscosity of the clarified milk can vary substantially at different temperatures. For example, milk separators may include discs that are responsible for separating the cream fraction from the skim fraction. As such, a cold milk separator can be designed with fewer discs (more space between discs) in comparison to a hot milk separator in order to ensure that higher viscosity of milk at cold temperatures does not plug the milk separator.

In various embodiments, the milk separator is a high speed centrifuge (otherwise known as an ultracentrifuge) that is capable of applying centrifugation speeds of 50,000×g and higher. An example of a milk separator is a Tetra Pak® Separator. Given that the cream fraction possesses a lower density than that of the skim fraction, the application of a pre-determined centrifugation speed for a duration of time effectively separates the skim fraction from the cream fraction. As such, each individual fraction can be individually collected and subsequently processed. The skim fraction is provided to a milk concentrator whereas the cream fraction is provided directly to the milk combiner. In an embodiment, the cream fraction is temporarily stored or held while the skim fraction undergoes further processing by the milk concentrator.

The concentrator further concentrates the skim fraction into a retentate. In an embodiment, the concentrator is a membrane filtration device that performs reverse osmosis on the skim fraction in order to concentrate the components (e.g., salts, proteins, HMOs) that are in the skim fraction.

In some embodiments, the concentrator concentrates the skim fraction to obtain a retentate that has a target concentration of a component. For example, the concentrator may detect, through a sensor or a similar device, the initial concentration of a component in the skim fraction. An example component concentration may be the protein concentration, individual amino acid concentrations, or vitamin concentrations. The retentate with a target concentration of a component is then provided to the milk combiner.

The milk combiner engineers a standardized human milk product by combining portions of the cream fraction and the retentate (e.g., concentrated skim fraction). In various embodiments, to achieve the desired concentrations in the standardized human milk product, the milk combiner may further supplement water that was originally removed by the concentrator when concentrating the skim sample.

In some embodiments, the milk combiner is configured with one or more sensors for detecting characteristics of the cream fraction, retentate, or both. For example, a detectable characteristic may be a solution density or total calories of the cream fraction or retentate. Alternatively or in addition, the sensor may be configured to detect concentrations of components in the cream fraction or retentate. More specifically, a sensor of the milk combiner may detect a concentration of protein in the retentate and a concentration of lipid (e.g., fat) in the cream fraction. Other components detectable by the sensor include specific amino acids, vitamins, carbohydrates, oligosaccharides, and immunoglobulins.

In various embodiments, the milk combiner may be further configured to perform computations, or be in communication with a computing system that performs computations. In some embodiments, the milk combiner includes the computing system. Such a computing system is hereafter referred to as the computing system of the milk combiner. The computing system can calculate the desired portion of the cream fraction and retentate that are to be combined according to the detected characteristics or concentration of components of the cream fraction and retentate detected by the sensor of the milk combiner. Additionally, the computing system may be configured with a memory that, in some embodiments, stores a target characteristic or concentration of a component of the standardized human milk product.

As described above, one example of a stored target characteristic or target concentration of a component is an initial characteristic or initial concentration of a component of the raw human breast milk 110 that was previously sampled. As another example, a stored target characteristic or target concentration of a component may be fixed number that is pre-determined. Therefore, the milk combiner attempts to engineer a standardized milk product that achieves the target characteristic or target concentration of a component. In various embodiments, achieving a target characteristic or concentration of component refers to achieving a characteristic or concentration of a component that is less than a percentage difference in comparison to the initial characteristic or initial concentration of a component of the raw human breast milk. In other embodiments, achieving a target characteristic or concentration of component refers to achieving a characteristic or concentration of a component that is less than a percentage difference in comparison to the fixed, pre-determined number.

As a more specific example, achieving a target density means that the standardized human milk product possesses a density that is less than a 10% difference in comparison to the stored target density. As another example, achieving a target protein concentration means that the standardized human milk product possesses a protein concentration that is less than a 5% difference in comparison to a stored target protein concentration. As a third example, achieving a target lipid concentration means that the standardized human milk product possesses a lipid concentration that is less than a 5% difference in comparison to a stored target lipid concentration.

In an example embodiment, the milk combiner receives the cream fraction and retentate and detects, using the one or more sensors, the characteristics and/or concentrations of components in the cream fraction and retentate. The computing system of the milk combiner compares the detected characteristics and/or concentrations of components to the stored target characteristics and/or concentration of components. In one embodiment, the computing system identifies a single characteristic or component as the standard and determines the portion of the cream fraction and the retentate that are to be combined such that the standardized human milk product achieves the desired standard characteristic or component concentration. For example, the standardized human milk product can be engineered by combining a portion of the cream fraction and retentate to possess a target concentration of protein in the standardized milk product.

In various embodiments, to engineer a standardized human milk product, the computing system prioritizes the characteristics and/or components of the standardized human milk product that are to be achieved. In one embodiment, the priority order of characteristics is as follows: 1) density, 2) protein concentration, and 3) lipid concentration. In other embodiments, other priority orders are established. As an example of this priority order, the computing system can first determine a first portion of the cream fraction and first portion of the retentate that are to be combined to achieve the desired density (e.g., within a pre-designated percentage difference). Next, the computing system determines whether combining the first portion of the cream fraction and the first portion of the retentate also achieves the desired protein concentration (e.g., within the percentage difference). If not, the computing system may adjust the volumes of the first portion of the cream fraction and first portion of the retentate to satisfy the desired protein concentration while also maintaining the desired density. Similarly, the computing system can perform the same check for the lipid concentration. Therefore, in some embodiments, the computing system may calculate a standardized human milk product that achieves all characteristics that are included in the priority order of characteristics. In other embodiments, the computing system may generate a standardized human milk product that meets a subset of the characteristics according to the priority order of characteristics.

The milk combiner combines the portions of the cream fraction and the retentate, as calculated by the computing system of the milk combiner. In various embodiments, the milk combiner 150 further hydrates the combined portions of the cream fraction and retentate. As such, the milk combiner engineers a standardized human milk product. The standardized human milk product is provided to the next device in the system 100.

In some embodiments, the milk standardizer 120 provides the standardized milk product to a milk homogenizer (not shown in FIG. 1) that is located in-line between the milk standardizer 120 and the milk fortifier 125.

In some embodiments, the milk standardizer 120 outputs the standardized human milk product directly to the fortifier 125, as shown in FIG. 1. Specifically, in these embodiments, the standardized milk product provided to the milk fortifier 125 is not previously homogenized by any prior device in the system 100. The lack of a homogenization step may help preserve the integrity of the components (e.g., proteins, HMOs, lipids, and the like) in the standardized milk product that may be otherwise disrupted or damaged by homogenization.

### 6.2.1.4. Milk Homogenizer

If included in system 100, a milk homogenizer homogenizes the human milk product input thereto.

For example, the milk homogenizer forces, using a pressure-driven flow, the standardized human milk product through a small physical passage at a high velocity, thereby disrupting the fat globules of the standardized milk product. Homogenization of the standardized human milk product may improve the long term stability of the milk product, improve the flavor of the milk product, and/or improve the appearance of the milk product. Depending on the intended use of the processed human milk product, these advantages may be outweighed by loss of nutritional value.

### 6.2.1.5. Fortifier

In various embodiments, fortifier 125 provides supplemental nutrients to achieve a target concentration of the added supplemental nutrients. In various embodiments, the fortifier 125 receives raw human milk 110 and provides supplemental nutrients to the raw human milk 110. The fortifier 125 can provide the fortified raw human milk to the milk processor 130. In various embodiments, the fortifier 125 receives clarified milk from the bacterial clarifier 115 and fortifies the clarified milk. In various embodiments, the fortifier 125 receives standardized milk from the milk standardizer 120 and fortifies the standardized milk. In various embodiments, the fortifier 125 receives processed milk from the milk processor 130 and fortifies the processed milk. Here, the supplemental nutrients provided by the fortifier 125 to the processed milk from the milk processor 130 can be independently processed. For example, the supplemental nutrients may be previously sterilized to ensure that the addition of the supplemental nutrients does not contaminate the processed milk from the milk processor 130.

In various embodiments, the fortifier 125 provides one or more of fat, antibodies (e.g., IgA, IgG, IgE, and the like), colostrum, such as bovine colostrum, protein (amino acids, whey, casein, albumin, enzymes, etc.), vitamins, cholesterol, ionic salts (e.g., sodium, magnesium, calcium, iron, etc.) carbohydrates, and human milk oligosaccharides as supplemental nutrients to the standardized human milk product.

In some embodiments, fortifier 125 adds a high net nitrogen utilization (NNU) protein composition, as described in U.S. Provisional Application No. 62/439,408, filed Dec. 27, 2016, incorporated herein by reference in its entirety.

In some embodiments, the milk product is fortified with flavorings. For example, the milk product can be fortified with stevia. In some embodiments, the milk product is fortified with natural colorings.

In some embodiments, the milk product is fortified with vitamins. In specific embodiments, the milk product is fortified with vitamin C. In specific embodiments, the milk product is fortified with vitamin D. In specific embodiments, the milk product is fortified with flavonoids, also referred to as vitamin plain. In specific embodiments, the milk product is fortified with flavored vitamins such as vitamin cherry.

In some embodiments, the milk product is fortified with minerals. In particular embodiments, the milk product is fortified with calcium. Calcium can be provided to the milk product in the form of calcium lactate. In certain embodiments, the milk product is fortified with magnesium. Magnesium can be provided in the form of magnesium bisglycinate or magnesium glycinate.

In some embodiments, the milk product is fortified with theanine, such as L-theanine. In some embodiments, the milk product is fortified with enzymes, such as Lacto enzymedica. In some embodiments, the milk product is fortified with methyl sulfonylmethane.

### 6.2.1.6. Deaerator

In various embodiments, the milk product can be deaerated to remove gasses from the milk product. The deaerator may receive a fortified milk sample from the fortifier 125. An aerator may be preferred as the fortification of a milk sample with supplemental nutrients can change the characteristics (e.g., density, caloric content, and viscosity) such that the fortified milk sample may experience difficulties (e.g., bubbling) when undergoing the processing step. In various embodiments, therefore, the method comprises deaerating the milk product before processing by milk processor 130. Examples of a deaerator device can include one of a tray-type deaerator, a spray-type deaerator, or a vacuum type deaerator.

### 6.2.1.7. Milk Processor

The milk processor 130 eliminates pathogens that are present in milk that is input thereto in order to ensure that the processed fortified human milk product 175 is suitable for remote consumption by an individual, such as an adult, an adolescent, infants, and premature infants.

As discussed above, in some embodiments milk processor 130 receives raw human breast milk 110 directly as input. In other embodiments, milk processor 130 receives clarified human breast milk as input. In other embodiments, milk processor 130 receives standardized milk product 170, either prior clarified or not prior clarified, as input. In some embodiments, the milk that is input into milk processor 130 has been fortified. In some embodiments, the input milk is not homogenized. In other embodiments, the input milk is homogenized. As used hereafter, the milk inputted into the milk processor 130 is referred to as the input milk product.

In one embodiment, the milk processor 130 heats the input milk product to a target temperature. Additionally, the input milk product is held at the target temperature for a particular amount of time, hereafter referred to as a hold time. Following processing, the milk processor 130 cools the heated milk product to a target temperature. In some embodiments, the target temperature after cooling is between 15° C. and 25° C. In one embodiment, the target temperature is room temperature (e.g., 23° C.). In other embodiments, the target temperature is between 1° C. and 8° C. such as refrigeration temperature (e.g., 4° C.). The cooled milk product outputted by the cooling medium is hereafter referred to as the processed fortified human milk product 175.

In some embodiments, the milk processor 130 processes the input milk product with limited changes to the temperature of the input milk product. An example is described below in reference to the irradiation treatment.

### 6.2.1.7.1. Ultra-High Temperature Sterilization

In some embodiments, the milk processor 130 performs an ultra-high temperature (UHT) sterilization process to produce the processed fortified human milk product 175.

The UHT process performed by the milk processor 130 can be a continuous flow process. More specifically, the input milk product flowing through the milk processor 130 can flow at a single, constant flow velocity. In a series of embodiments, the milk flow velocity is between 0.25 gallons to 25 gallons per minute. In various embodiments, the milk flow velocity is between 0.25 gallons to 15 gallons per minute. In various embodiments, the milk flow velocity is between 0.25 gallons to 5 gallons per minute. In some embodiments, the milk flow velocity is between 5-100 gallons per minute.

The milk processor 130 heats the input milk product to a target temperature and holds the input milk product at the target temperature for a predesignated hold time. In various embodiments, the target temperature may be between 130° C. and 150° C. In one embodiment, the second target temperature may be between 138° C. and 142° C. In one particular embodiment, the second target temperature is between 140° C. and 141° C.

In various embodiments, the predesignated hold time is selected such that the bacteria (e.g., B. Cereus and C. Botulinum) levels are reduced while maintaining the integrity of nutritional components (e.g. proteins, fats, immunoglobulins, oligosaccharides) in the processed fortified milk product. In one embodiment, the hold time is up to 50 seconds. In another embodiment, the hold time is between 2 seconds and 20 seconds. In some embodiments, the hold time is between 3 seconds and 15 seconds. In some embodiments, the hold time is between 6 and 14 seconds. In some embodiments, the hold time is between 8 and 13 seconds. In one embodiment, the hold time is between 12 and 13 seconds.

In various embodiments, the UHT sterilization process is an indirect heating process. In one scenario, the milk processor 130 that performs an indirect heating process uses a countercurrent exchange heating process. Here, the milk processor 130 employs a hold tube that holds the temperature of the heated milk product at or near the target temperature for the hold time (e.g., a pre-determined amount of time). The input milk product flows internally within the hold tube. Additionally, an external surface of the hold tube is in contact with a heating medium. The heating medium may flow within an external container, such as a vat. To achieve a desired hold time, the hold tube can be specifically configured. For example, the length of the tube can be configured such that with a given flow rate, the milk flowing through the hold tube is held at the target temperature for the hold time. As another example, the hold tube may be a spiral tube. Given a constant flow velocity of the milk through the tube, the spiral tube can be designed with additional or fewer spirals (e.g., additional or reduced length) to increase or decrease the hold time. Alternatively, for a constant length of the tube, the flow velocity of the milk through the tube can be tailored by adjusting the diameter of the hold tube. Therefore, increasing or decreasing the tube diameter results in a corresponding increase or decrease in the hold time. In various embodiments, the diameter of the tube may be between 0.25 inches and 10 inches. In some embodiments, the diameter of the tube is between 0.25 inches and 5 inches. In some embodiments, the diameter of the tube is between 0.25 inches and 1 inch. In some embodiments, the diameter of the tube is between 0.25 inches and 0.5 inches. In some embodiments, the diameter of the tube is 0.25 inches, 0.5 inches, 0.75 inches, 1 inch, 2 inches, 3 inches, 4 inches, 5 inches, 6 inches, 7 inches, 8 inches, 9 inches, or 10 inches.

In various embodiments, the flow of milk in the hold tube is in a first direction and the heating medium in contact with an external surface of the hold tube flows in a second direction. Therefore, countercurrent heat exchange can occur between the milk product that flows through the hold tube and a heating medium that is in contact with the hold tube. The preheating medium may be any type of heating fluid with a high specific heat capacity such as water, mineral oils, as well as synthetic or organic based solutions. In some embodiments, the preheating medium may include heated steam.

In various embodiments, the milk processor 130 preheats the milk product to a first target temperature and subsequently heats the milk product to the target temperature. As an example, the input milk product can be preheated from an initial temperature (e.g., between 0-25° C.) to a first target temperature of 90° C. In other examples, the target temperature may be between 80° C. and 100° C. The milk processor 130 may preheat the input milk product using a hold tube and the aforementioned process of countercurrent heat exchange.

In various embodiments, the UHT sterilization process is a direct heating process. In one scenario, the milk processor 130 performs a steam injection or steam infusion on the input milk product. For example, the milk processor 130 directly injects heated steam into the input milk product to heat the input milk product to the target temperature. In various embodiments, the heated steam is previously checked for quality to ensure that the steam is a high quality culinary steam and does not impart a flavor or appearance change to the input milk product.

The milk processor 130 blends the input milk product with the high pressure, heated steam using injectors and mixers. Here, mixing the high pressure, heated steam with the input milk product maximizes the efficiency of heat transfer to the input milk product.

After heating the input milk to the target temperature and holding for the hold time, the milk processor 130 removes the added heated steam. In various embodiments, the milk processor 130 performs an aseptic flash cooling process that evaporates the steam that was previously added. In one embodiment, the milk processor 130 applies a vacuum (e.g., through a vacuum chamber) that removes the steam as the milk product cools.

### 6.2.1.7.2. Low Temperature Long Time (Holder) Pasteurization

In some embodiments, the milk processor 130 performs a low temperature long time (LTLT) pasteurization process to produce the processed fortified human milk product 175. The LTLT pasteurization process can also be referred to as Holder pasteurization or Vat pasteurization. An example of a milk processor 130 for performing the LTLT pasteurization process can be a Vat/Batch Pasteurizer by C. Van 't Riet/Dairy Technology USA.

The milk processor 130 heats the input milk product to a target temperature and holds the input milk product at the target temperature for a predesignated hold time. In various embodiments, the target temperature may be about 62.5° C. In some embodiments, the target temperature may be at least 62° C. In some embodiments, the target temperature may be between 62° C. and 64.5° C. In some embodiments, the target temperature may be at least 65° C. In some embodiments, the target temperature may be at least 70° C. In some embodiments, the target temperature may be at least 63° C., 64° C., 65° C., 66° C., 67° C., 68° C., or 69° C.

In one embodiment, the hold time is at least 30 minutes. In another embodiment, the hold time is at least 45 minutes. In another embodiment, the hold time is at least 60 minutes. In some embodiments, the hold time is at least 31 minutes, 32 minutes, 33 minutes, 34 minutes, 35 minutes, 36 minutes, 37 minutes, 38 minutes, 39 minutes, 40 minutes, 41 minutes, 42 minutes, 43 minutes, or 44 minutes.

In some embodiments, the milk processor 130 may include a heating container, such as a heating vat. The input milk product is placed in the heating container and heated to the target temperature and held for the hold time. In various embodiments, the input milk product is stirred while undergoing the heating process. In various embodiments, the heating container heats the input milk product through electrical means. In some embodiments, the heating container heats the input milk product through other means such as heat exchange using heated mediums including heated steam, heated gasses, or heated fluid.

In some embodiments, the milk processor 130 performs the heating of the input milk product using a counter-current exchange. Here, the LTLT pasteurization process performed by the milk processor 130 can be a continuous flow process. More specifically, the milk flowing through the milk processor 130 can flow at a single, constant flow velocity. In a series of embodiments, the milk flow velocity is between 0.25 gallons to 25 gallons per minute. In various embodiments, the milk flow velocity is between 0.25 gallons to 15 gallons per minute. In various embodiments, the milk flow velocity is between 0.25 gallons to 5 gallons per minute. In some embodiments, the milk flow velocity is between 5-100 gallons per minute. The milk processor 130 may heat the input milk product using a heating medium such as heated steam, heated gas, or heated fluid.

### 6.2.1.7.3. High Temperature Short Time Pasteurization

In some embodiments, the milk processor 130 performs a high temperature short time (HTST) pasteurization process to generate the processed fortified human milk product 175. The HTST pasteurization process is also referred to as a flash pasteurization process. An example of a milk processor 130 for performing the HTST pasteurization process can be the GEA compact milk pasteurizer MWA for milk, cream and whey.

The milk processor 130 heats the input milk product to a target temperature and holds the input milk product at the target temperature for a predesignated hold time. In various embodiments, the target temperature may be about 71° C. In some embodiments, the target temperature may be at least 71° C. In some embodiments, the target temperature may be at least 75° C. In some embodiments, the target temperature may be at least 80° C. In some embodiments, the target temperature may be at least 72° C., 73° C., 74° C., 75° C., 76° C., 77° C., 78° C., 79° C., or 80° C.

In one embodiment, the hold time is at least 15 seconds. In another embodiment, the hold time is at least 30 seconds. In another embodiment, the hold time is at least 60 seconds. In some embodiments, the hold time is at least 16 seconds, 17 seconds, 18 seconds, 19 seconds, 20 seconds, 21 seconds, 22 seconds, 23 seconds, 24 seconds, 25 seconds, 26 seconds, 27 seconds, 28 seconds, or 29 seconds.

In some embodiments, the milk processor 130 may include a heating container, such as a heating vat. The input milk product is placed in the heating container and heated to the target temperature and held for the hold time. In various embodiments, the heating container heats the input milk product through electrical means. In some embodiments, the heating container heats the input milk product through other means such as heat exchange using heated mediums including heated steam, heated gasses, or heated fluid.

In some embodiments, the milk processor 130 performs the heating of the input milk product using a counter-current exchange. Here, the HTST pasteurization process performed by the milk processor 130 can be a continuous flow process. More specifically, the milk flowing through the milk processor 130 can flow at a single, constant flow velocity. In a series of embodiments, the milk flow velocity is between 0.25 gallons to 25 gallons per minute. In various embodiments, the milk flow velocity is between 0.25 gallons to 15 gallons per minute. In various embodiments, the milk flow velocity is between 0.25 gallons to 5 gallons per minute. In some embodiments, the milk flow velocity is between 5-100 gallons per minute. The milk processor 130 may heat the input milk product using a heating medium such as heated steam, heated gas, or heated fluid.

### 6.2.1.7.4. Thermization Processing

In some embodiments, the milk processor 130 performs a thermization sanitation process to generate the processed fortified human milk product 175. The thermization sanitation process sanitizes the input milk product with low heat. Specifically, the thermization sanitation process partially removes pathogens while maintaining beneficial bacterial flora.

The milk processor 130 heats the input milk product to a target temperature and holds the input milk product at the target temperature for a predesignated hold time. In various embodiments, the target temperature may be between 63° C. and 65° C. In some embodiments, the target temperature is 64° C. In some embodiments, the target temperature may be at least 65° C., 66° C., 67° C., 68° C., 69° C., or 70° C.

In one embodiment, the hold time is at least 15 seconds. In another embodiment, the hold time is at least 30 seconds. In another embodiment, the hold time is at least 60 seconds. In some embodiments, the hold time is at least 16 seconds, 17 seconds, 18 seconds, 19 seconds, 20 seconds, 21 seconds, 22 seconds, 23 seconds, 24 seconds, 25 seconds, 26 seconds, 27 seconds, 28 seconds, or 29 seconds.

In some embodiments, the milk processor 130 may include a heating container, such as a heating vat. The input milk product is placed in the heating container and heated to the target temperature and held for the hold time. In various embodiments, the heating container heats the input milk product through electrical means. In some embodiments, the heating container heats the input milk product through other means such as heat exchange using heated mediums including heated steam, heated gasses, or heated fluid.

In some embodiments, the milk processor 130 performs the heating of the input milk product using a counter-current exchange. Here, the HTST pasteurization process performed by the milk processor 130 can be a continuous flow process. More specifically, the milk flowing through the milk processor 130 can flow at a single, constant flow velocity. In a series of embodiments, the milk flow velocity is between 0.25 gallons to 25 gallons per minute. In various embodiments, the milk flow velocity is between 0.25 gallons to 15 gallons per minute. In various embodiments, the milk flow velocity is between 0.25 gallons to 5 gallons per minute. In some embodiments, the milk flow velocity is between 5-100 gallons per minute. The milk processor 130 may heat the input milk product using a heating medium such as heated steam, heated gas, or heated fluid.

### 6.2.1.7.5. In-Container Sterilization

In some embodiments, the milk processor 130 performs an in-container sterilization process to generate the processed fortified human milk product 175. The in-container sterilization process is also referred to as a retort process. Examples of devices that can be used to perform the in-container sterilization process include the Allpax 1300 Shaka retort or the Allpax 1600 Shaka retort.

Retort processing can be a batch or continuous process that provides in-container sterilization to the milk. In these embodiments, the milk processor 130 receives input milk product that has been packaged in a container. As an example, returning to FIG. 1, the fortifier 125 can fortify a milk product and provide the input milk product for packaging. In various embodiments, the input milk product can be packaged in a retortable glass container, can, pouch, or plastic bottle. The input milk packaged in the retortable container is provided to the milk processor 130 to perform the in-container sterilization. In various embodiments, the retortable container with the input milk product is degassed to remove air and oxygen prior to sealing the retortable container. In various embodiments, the milk processor 130 that performs the in-container sterilization process is a steam retort, water spray retort, or a water immersion retort.

The milk processor 130 heats the retortable container including the input milk product to a target temperature and holds the input milk product at the target temperature for a predesignated hold time. In some embodiments, the target temperature may be between 110° C. and 130° C. In some embodiments, the target temperature may be between 115° C. and 121° C. In some embodiments, the target temperature may be 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., or 129° C.

In one embodiment, the hold time is between 3 minutes to 30 minutes. In another embodiment, the hold time is between 5 minutes to 20 minutes. In some embodiments, the hold time is 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, or 29 minutes.

In various embodiments, once the processed fortified milk product has undergone in-container sterilization, the processed fortified milk product need not undergo further processing and packaging.

### 6.2.1.7.6. Irradiation Treatment

In some embodiments, the milk processor 130 performs an irradiation treatment to generate the processed fortified human milk product 175. The irradiation treatment sanitizes the input milk product by providing an ionizing form of radiation that eliminates pathogens in the input milk product. The irradiation treatment includes the provision of radiation to the input milk product. Examples of radiation include gamma rays (e.g., gamma rays emitted from radioactive forms of cobalt or cesium), x-rays, or electron beams. In various embodiments, the irradiation treatment performed on the input milk product increases the temperature of the input milk product. In some embodiments, the input milk product is held at a near constant temperature while the irradiation treatment is performed on the input milk product.

Irradiation of the input milk product can be performed at a dedicated food irradiation plant. As an example, the dedicated food irradiation plant can include a conveyer system that, as the input milk product moves along the conveyer, exposes the input milk product to a specified dose of radiation for a target amount of time. In one embodiment, a low dose of radiation provided to the input milk product is between 0.01 to 1.0 kilograys. I another embodiment, a dose of radiation provided to the input milk product is between 1.0 kilograys and 70 kilograys. In another embodiment, a medium dose of radiation provided to the input milk product is between 1.0 and 10 kilograys. In another embodiment, a high dose of radiation provided to the input milk product is above 10 kilograys (e.g., between 10 and 70 kilograys).

In various embodiments, the amount of time that the input milk product is exposed to radiation is between 1 second to 45 minutes. In various embodiments, the amount of time that the input milk product is exposed to radiation is between 1 second to 300 seconds. For example, the input milk product may be exposed to 1 to 300 seconds of electron beams. In some embodiments, the amount of time that the input milk product is exposed to radiation is between 15 minutes to 45 minutes. For example the input milk product may be exposed to 15 to 45 minutes of gamma rays.

In various embodiments, the milk processor 130 receives input milk product that has been packaged in a container prior to providing radiation. In various embodiments, the input milk product can be packaged in a container such as a can, pouch, or bottle. Such a container can be composed of a polymer that, when exposed to radiation, does not interact with the input milk product (e.g., does not change the composition, taste, or appearance of the input milk product). Examples of polymers can include polystyrene, poly-butadiene, and acrylonitrile. In these embodiments, after the input milk product is treated with radiation, the milk product need not undergo further packaging.

### 6.2.1.7.7. Microwave Treatment

In some embodiments, the milk processor 130 performs a microwave treatment to generate the processed fortified human milk product 175. The microwave treatment sanitizes the input milk product. An example of the microwave treatment can be a microwave assisted thermal treatment process that eliminates pathogens in the input milk product by holding the input milk product under pressure and at a controlled temperature. In one embodiment, the microwave applies a microwave with a frequency between 900 and 1000 MHz. In another embodiment, the microwave applies a microwave with frequency between 2100 and 2600 MHz.

To perform the microwave treatment, the milk processor 130 heats the input milk product to a target temperature by providing the microwaves. In various embodiments, the target temperature may be between 70° C. and 130° C. In various embodiments, the target temperature may be between 70° C. and 90° C. In some embodiments, the target temperature is 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., or 89° C. In some embodiments, the target temperature may be between 110° C. and 130° C. In some embodiments, the target temperature may be 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., or 129° C.

The process of heating the input milk product may use a pre-designated amount of time. In one embodiment, the pre-designated amount of time is between 1 minute and 20 minutes. In one embodiment, the pre-designated amount of time is between 1 minute and 2 minutes. In some embodiments, the pre-designated amount of time is at least 1.5 minutes. In some embodiments, the pre-designated amount of time is between 4 and 20 minutes. In some embodiments, the pre-designated amount of time is between 5 and 8 minutes. In some embodiments, the pre-designated amount of time is between 15 and 20 minutes. In some embodiments, the pre-designated amount of time is 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, or 19 minutes.

In various embodiments, the milk processor 130 receives input milk product that has been packaged in a container prior to undergoing microwave treatment. In various embodiments, the input milk product can be packaged in a container such as a tray, can, pouch, or bottle. Such a container can be composed of a polymer that, when exposed to microwaves, does not interact with the input milk product (e.g., does not change the composition, taste, or appearance of the input milk product). Examples of polymers can include polyethylene, polystyrene, poly-butadiene, and acrylonitrile. In these embodiments, after the input milk product is treated with microwaves, the milk product need not undergo further packaging.

### 6.2.1.8. Further Processing and Packaging

In some embodiments, the processed fortified human milk product 175 obtained from the closed in-line processing system 100 can be further processed and/or packaged.

As an example, the processed fortified human milk product 175 may further undergo a packaging step. In various embodiments, this packaging step is an aseptic packing process that ensures that the processed fortified human milk product 175 remains unadulterated and is safe for consumption. Such an aseptic packaging process may include the steps of package unscrambling, aseptic filling of the package with the processed fortified human milk product 175, heat sealing of the package, labeling and coding of the package, tamper-evident sealing of the package, and container bundling. In other embodiments, the packaging process is an extended shelf-life (ESL) packaging process. In various embodiments, the processed fortified human milk product 175 is packaged into a bottle or a booster cup that facilitates the feeding of the processed fortified human milk product 175 to an infant, such as a premature. In some embodiments, the packaging may be a paper carton, paper brick (e.g., a TETRA PAK® aseptic brick), or a pouch.

In some embodiments, including those preferred for processed fortified human milk product 175 suitable for consumption by adults, the processed fortified human milk product 175 is aseptically packaged and meets pharmaceutical sterilization standards. More specifically, even if the processed fortified human milk product 175 is exposed to oxygen (e.g., the packaging is opened), the processed fortified human milk product 175 remains sterile and safe for consumption as pathogenic microbes have been sufficiently eradicated during processing. In other embodiments, the processed fortified human milk product 175 is ESL packaged and therefore, can remain safe for consumption for extended periods of time after packaging.

### 6.2.1.9. Device Standards

Altogether, the devices of the system 100 are each designed to meet certain standards.

For example, in one embodiment, the bacterial clarifier 115, the milk standardizer 120, and the fortifier 125 each meet Grade “A” pasteurized milk ordinance (PMO) standards. Milk processor 130 can be designed to meet PMO standards. In some embodiments, milk processor 130 is designed to meet even higher standards; namely, the milk processor 130 can be designed to meet GMP standards or pharmaceutical grade standards. As an example, to meet GMP or pharmaceutical grade standards, hygienic welds are employed while threaded fittings are avoided in the milk processor 130. In various embodiments, the system 100 is a clean-in-place (CIP) system, meaning that the system 100 need not be disassembled to be cleaned.

### 6.2.2. Methods of Generating Processed Human Milk Product

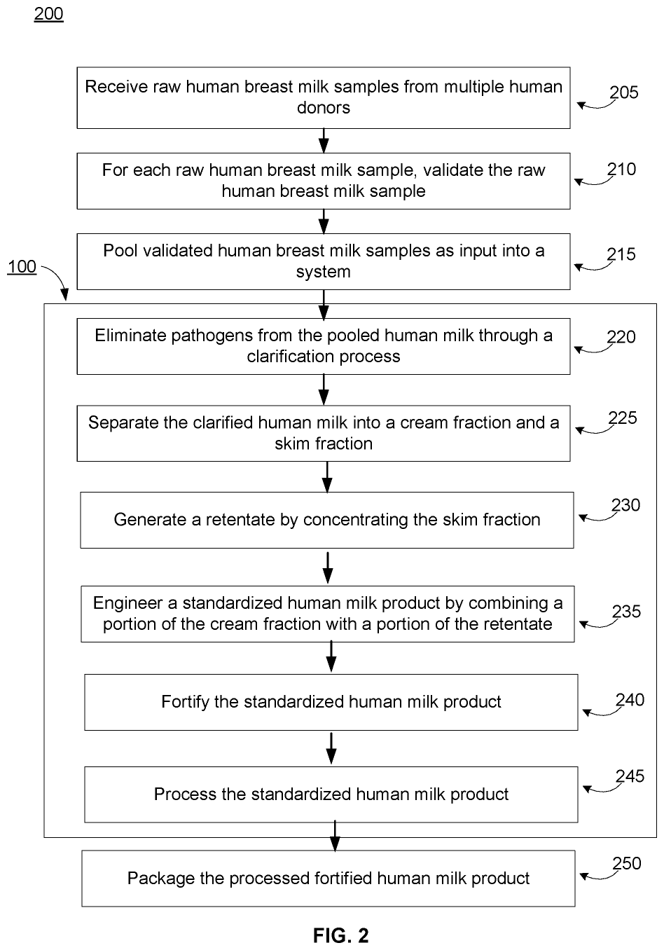

Reference is now made to FIG. 2, which depicts a flow chart for generating a processed human milk product, in accordance with an embodiment of the present invention.

The raw human breast milk 110 is first obtained. In typical embodiments, for example, individual raw breast milk donations (samples) are received 205 from multiple human donors. Each of the raw human breast milk donations is validated 210 to determine whether any donation fails to meet quality control standards. If a donation fails quality control standards, it is then discarded. The validated samples are pooled 215. The pooled validated samples represent the raw human breast milk 110 that is then provided as input into the system 100.

### 6.2.2.1. Methods of Generating Processed Fortified Human Milk Product

Processed fortified human milk product can be a nutritional composition intended for consumption by infants or by adults. In one embodiment, the processed fortified human milk product can possess high nutrient content while also maintaining a desirable level of sterility (e.g., lack of pathogens).

Accordingly, with continued reference to FIG. 2, in some embodiments system 100 eliminates 220 a portion (e.g., up to 90%) of pathogens from the raw human breast milk 110 through a clarification process. In various embodiments, the process is a single bacterial clarification process performed by a single bacterial clarifier 115 of the system 100. In various embodiments, the process is a double bacterial clarification process performed by two or more bacterial clarifiers 115 of the system 100. Processed fortified human milk product intended for remote consumption by adults requires less stringent sterility than processed human milk product intended for remote consumption by infants, and particularly premature infants. Accordingly, in some embodiments, the method of producing a processed fortified human milk product for consumption by adults omits bacterial clarification.

Human milk, either with or without prior clarification, is input into milk standardizer 120. Milk standardizer 120 separates 225 the clarified human milk into a cream fraction and a skim fraction. The milk standardizer 120 generates 230 a retentate by concentrating the skim fraction. In various embodiments, the device that concentrates the skim fraction is a membrane filtration device that performs a reverse osmosis process on the skim fraction in order to generate the retentate. The milk standardizer 120 engineers 235 a standardized human milk product by combining a portion of the cream fraction with a portion of the retentate. However, processed fortified human milk product intended for remote consumption by adults requires less stringent standardization than processed fortified human milk product intended for remote consumption by infants, and particularly premature infants. Accordingly, in some embodiments, the method omits standardization.

The human milk product, either with or without clarification and with or without standardization, is provided to the fortifier 125 that fortifies the standardized human milk product with additional nutrients such as lipid/fat, protein (amino acids, whey, casein, albumin, enzymes, etc.), vitamins, cholesterol, ionic salts (e.g., sodium, calcium, iron, etc.) carbohydrates, immunoglobulins, and oligosaccharides such as human milk oligosaccharides. In specific embodiments, the method comprises fortifying the standardized milk product with colostrum. In typical embodiments, the colostrum is bovine colostrum. In certain embodiments, the colostrum is sheep or goat colostrum. In certain embodiments, the method comprises fortifying the standardized milk product with protein or a high net nitrogen utilization (NNU) protein composition, as described in U.S. provisional application No. 62/439,408, filed Dec. 27, 2016, incorporated herein by reference in its entirety.

In various embodiments of methods of producing processed fortified human milk products intended for remote consumption by adults, homogenization is omitted. In other embodiments, the milk product is homogenized. In certain embodiments, the milk product is homogenized before processing. In other embodiments, the milk product is homogenized after processing. In other embodiments, the milk product is homogenized during an intermediate step of processing (e.g., after preheating and prior to heating to a second target temperature).

The system 100 processes 245 the fortified human milk product. In various embodiments, the milk processor 130 performs an ultra-high temperature sterilization process. In various embodiments, the ultra-high temperature sterilization process is an indirect heating process. In various embodiments, the ultra-high temperature sterilization process is a direct heating process. In some embodiments, the milk processor 130 performs a low temperature long time pasteurization process. In some embodiments, the milk processor 130 performs a high temperature short time pasteurization process. In some embodiments, the milk processor 130 performs a thermization sanitation process. In some embodiments, the milk processor 130 performs an in-container sterilization process. In some embodiments, the milk processor 130 performs an irradiation treatment. In some embodiments, the milk processor 130 performs a microwave treatment.

The milk processor 130 cools the heated human milk product down from the heated temperature to obtain the processed fortified human milk product 175. In various embodiments, the processed fortified human milk product 175 is cooled to room temperature between 15° C. to 25° C. In other embodiments, the processed fortified human milk product 175 is cooled to a refrigeration temperature between 1° C. and 8° C.

The processed fortified human milk product 175 is provided by the milk processor 130 and is packaged 250. In various embodiments, this may be an aseptic packaging process to ensure that the processed fortified human milk product is not contaminated prior to being provided for human consumption. In such embodiments, the aseptically packaged processed fortified human milk product may be distributed without refrigeration.

### 6.3. Compositions of Processed Fortified Human Milk Product

In various embodiments, the processed fortified human milk product 175 has 80-120 calories/100 g of processed fortified human milk product, 90-110 calories/100 g, or 95-105 calories/100 g. In some embodiments, the processed fortified human milk product 175 has 91, 92, 93, 94, 95, 96, 97, 98, 99, 100, 101, 102, 103, 104, 105, 106, 107, 108, or 109 calories/100 g. In particular embodiments, the processed fortified human milk product 175 has between 95.0 and 100.0 calories/100 g. In certain embodiments, the processed fortified human milk product 175 has 95.5 to 96.5 calories/100 g.

In various embodiments, the processed fortified human milk product 175 has a total fat content between 3.0 g/100 g (3 wt %) and 5 wt %. In some embodiments, the processed fortified human milk product 175 includes 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, or 4.9 wt %. In some embodiments, the processed fortified human milk product 175 has a total fat content of greater than 5.0 wt %.

In various embodiments, the processed fortified human milk product 175 includes between 1.1 g to 2.3 g of saturated fat per 100 g of the processed fortified human milk product 175. In some embodiments, the processed fortified human milk product 175 includes 1.2 g, 1.3 g, 1.4 g, 1.5 g, 1.6 g, 1.7 g, 1.8 g, 1.9 g, 2.0 g, 2.1 g, or 2.2 g of saturated fat per 100 g of the processed fortified human milk product 175. In some embodiments, the processed fortified human milk product 175 includes between 14 mg and 22 mg of cholesterol per 100 g of the processed fortified human milk product 175. In various embodiments, the processed fortified human milk product 175 includes 15 mg, 16 mg, 17 mg, 18 mg, 19 mg, 20 mg, or 21 mg of cholesterol per 100 g of the processed fortified human milk product 175. In some embodiments, the processed fortified human milk product 175 includes between 17 mg and 26 mg of sodium per 100 g of the processed fortified human milk product 175. In various embodiments, the processed fortified human milk product 175 includes 18 mg, 19 mg, 20 mg, 21 mg, 22 mg, 23 mg, 24 mg, or 25 mg of sodium per 100 g of the processed fortified human milk product 175. In some embodiments, the processed fortified human milk product 175 includes between 3 g and 13 g of carbohydrates per 100 g of the processed fortified human milk product 175. In various embodiments, the processed fortified human milk product 175 includes 4 g, 5 g, 6 g, 7 g, 8 g, 9 g, 10 g, 11 g, or 12 g of carbohydrates per 100 g of the processed fortified human milk product 175. In some embodiments, the processed fortified human milk product 175 includes between 2 g and 9 g of sugar per 100 g of the processed fortified human milk product 175. In various embodiments, the processed fortified human milk product 175 includes 3 g, 4 g, 5 g, 6 g, 7, or 8 g of sugar per 100 mL of the processed fortified human milk product 175. In some embodiments, the processed fortified human milk product 175 includes between 99 mg and 121 mg of calcium per 100 g of the processed fortified human milk product 175. In various embodiments, the processed fortified human milk product 175 includes 100 mg, 101 mg, 102 mg, 103 mg, 104 mg, 105 mg, 106 mg, 107 mg, 108 mg, 109 mg, 110 mg, 111 mg, 112 mg, 113 mg, 114 mg, 115 mg, 116 mg, 117 mg, 118 mg, 119 mg, or 120 mg of calcium per 100 g of the processed fortified human milk product 175. In some embodiments, the processed fortified human milk product 175 includes between 5.9 g and 9.1 g of protein (F=6.38) per 100 g of the processed fortified human milk product 175. In various embodiments, the processed fortified human milk product 175 includes 6.0 g, 6.1 g, 6.2 g, 6.3 g, 6.4 g, 6.5 g, 6.6 g, 6.7 g, 6.8 g, 6.9 g, 7.0 g, 7.1 g, 7.2 g, 7.3 g, 7.4 g, 7.5 g, 7.6 g, 7.7 g, 7.8 g, 7.9 g, 8.0 g, 8.1 g, 8.2 g, 8.3 g, 8.4 g, 8.5 g, 8.6 g, 8.7 g, 8.8 g, 8.9 g, or 9.0 g of protein per 100 g of the processed fortified human milk product 175.

In some embodiments, the processed fortified human milk product 175 has a protein digestibility corrected amino acid score (PDCAAS) of 100%. In some embodiments, the processed fortified human milk product 175 has a protein digestibility corrected amino acid score of at least 90%. In some embodiments, the processed fortified human milk product 175 has a protein digestibility corrected amino acid score of at least 65%. In some embodiments, the processed fortified human milk product 175 has a protein digestibility corrected amino acid score of at least 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%.

In some embodiments, the processed fortified human milk product 175 has an amino acid score between 1.1 and 1.4. In some embodiments, the processed fortified human milk product 175 has an amino acid score between 1.2 and 1.3. In some embodiments, the processed fortified human milk product 175 has an amino acid score of 1.21, 1.22, 1.23, 1.24, 1.25, 1.26, 1.27, 1.28, or 1.29. In some embodiments, the processed fortified human milk product 175 has an amino acid score of at least 0.70. In some embodiments, the processed fortified human milk product 175 has an amino acid score of at least 0.80. In some embodiments, the processed fortified human milk product 175 has an amino acid score of at least 0.90.

In some embodiments, the processed fortified human milk product 175 includes between 0.10% and 0.20% (w/w) of alanine. In some embodiments, the processed fortified human milk product 175 includes 0.10%, 0.11%, 0.12%, 0.13%, 0.14%, 0.15%, 0.16%, 0.17%, 0.18%, 0.19%, or 0.20% (w/w) alanine. In some embodiments, the processed fortified human milk product 175 includes between 0.08% and 0.20% (w/w) of arginine. In some embodiments, the processed fortified human milk product 175 includes 0.09%, 0.10%, 0.11%, 0.12%, 0.13%, 0.14%, 0.15%, 0.16%, 0.17%, 0.18%, or 0.19% (w/w) arginine. In some embodiments, the processed fortified human milk product 175 includes between 0.26% and 0.38% (w/w) of aspartic acid. In some embodiments, the processed fortified human milk product 175 includes 0.27%, 0.28%, 0.29%, 0.30%, 0.31%, 0.32%, 0.33%, 0.34%, 0.35%, 0.36%, or 0.37% (w/w) aspartic acid. In some embodiments, the processed fortified human milk product 175 includes between 0.04% and 0.12% (w/w) of cysteine. In some embodiments, the processed fortified human milk product 175 includes 0.04%, 0.05%, 0.06%, 0.07%, 0.08%, 0.09%, 0.10%, or 0.11% (w/w) cysteine. In some embodiments, the processed fortified human milk product 175 includes between 0.60% and 0.70% (w/w) of glutamic acid. In some embodiments, the processed fortified human milk product 175 includes 0.61%, 0.62%, 0.63%, 0.64%, 0.65%, 0.66%, 0.67%, 0.68%, 0.69%, or 0.70% (w/w) glutamic acid.

In some embodiments, the processed fortified human milk product 175 includes between 0.05% and 0.15% (w/w) of glycine. In some embodiments, the processed fortified human milk product 175 includes 0.06%, 0.07%, 0.08%, 0.09%, 0.10%, 0.11%, 0.12%, 0.13%, 0.14%, or 0.15% (w/w) of glycine. In some embodiments, the processed fortified human milk product 175 includes between 0.13% and 0.23% (w/w) of histidine. In some embodiments, the processed fortified human milk product 175 includes 0.14%, 0.15%, 0.16%, 0.17%, 0.18%, 0.19%, 0.20%, 0.21%, 0.22%, or 0.23% (w/w) of histidine. In some embodiments, the processed fortified human milk product 175 includes between 0.75% and 0.90% (w/w) of isoleucine. In some embodiments, the processed fortified human milk product 175 includes 0.76%, 0.77%, 0.78%, 0.79%, 0.80%, 0.81%, 0.82%, 0.83%, 0.84%, 0.85%, 0.86%, 0.87%, 0.88%, or 0.89% (w/w) of isoleucine. In some embodiments, the processed fortified human milk product 175 includes between 1.20% and 1.35% (w/w) of leucine. In some embodiments, the processed fortified human milk product 175 includes 1.21%, 1.21%, 1.22%, 1.23%, 1.24%, 1.25%, 1.26%, 1.27%, 1.28%, 1.29%, 1.30%, 1.31%, 1.32%, 1.33%, or 1.34% (w/w) of leucine.

In some embodiments, the processed fortified human milk product 175 includes between 0.70% and 0.85% (w/w) of lysine. In some embodiments, the processed fortified human milk product 175 includes 0.71%, 0.72%, 0.73%, 0.74%, 0.75%, 0.76%, 0.77%, 0.78%, 0.79%, 0.80%, 0.81%, 0.82%, 0.83%, or 0.84% (w/w) of lysine. In some embodiments, the processed fortified human milk product 175 includes between 0.35% and 0.45% (w/w) of methionine. In some embodiments, the processed fortified human milk product 175 includes 0.36%, 0.37%, 0.38%, 0.39%, 0.40%, 0.41%, 0.42%, 0.43%, or 0.44%, (w/w) of methionine. In some embodiments, the processed fortified human milk product 175 includes between 0.70% and 0.90% (w/w) of phenylalanine. In some embodiments, the processed fortified human milk product 175 includes 0.71%, 0.72%, 0.73%, 0.74%, 0.75%, 0.76%, 0.77%, 0.78%, 0.79%, 0.80%, 0.81%, 0.82%, 0.83%, 0.84%, 0.85%, 0.86%, 0.87%, 0.88%, or 0.89% (w/w) of phenylalanine. In another embodiment, the processed fortified human milk product 175 can include a minimal amount of phenylalanine to avoid inducing possible individual allergies to phenylalanine. For example, the processed fortified human milk product 175 can include at most 0.1% phenylalanine. In some embodiments, the processed fortified human milk product 175 can include at most 0.05% phenylalanine. In some embodiments, the processed fortified human milk product 175 can include at most 0.01% phenylalanine.

In some embodiments, the processed fortified human milk product 175 includes between 0.25 and 0.40% (w/w) of proline. In some embodiments, the processed fortified human milk product 175 includes 0.26%, 0.27%, 0.28%, 0.29%, 0.30%, 0.31%, 0.32%, 0.33%, 0.34%, 0.35%, 0.36%, 0.37%, 0.38%, or 0.39% (w/w) of proline. In some embodiments, the processed fortified human milk product 175 includes between 0.20 and 0.35% (w/w) of serine. In some embodiments, the processed fortified human milk product 175 includes 0.21%, 0.22%, 0.23%, 0.24%, 0.25%, 0.26%, 0.27%, 0.28%, 0.29%, 0.30%, 0.31%, 0.32%, 0.33%, or 0.34% (w/w) of serine. In some embodiments, the processed fortified human milk product 175 includes between 0.64 and 0.80% (w/w) of threonine. In some embodiments, the processed fortified human milk product 175 includes 0.65%, 0.66%, 0.67%, 0.68%, 0.69%, 0.70%, 0.71%, 0.72%, 0.73%, 0.74%, 0.75%, 0.76%, 0.77%, 0.78%, or 0.79%, (w/w) of threonine.

In some embodiments, the processed fortified human milk product 175 includes between 0.10 and 0.25% (w/w) of tryptophan. In some embodiments, the processed fortified human milk product 175 includes 0.11%, 0.12%, 0.13%, 0.14%, 0.15%, 0.16%, 0.17%, 0.18%, 0.19%, 0.20%, 0.21%, 0.22%, 0.23%, or 0.24% (w/w) of tryptophan. In some embodiments, the processed fortified human milk product 175 includes between 0.10 and 0.25% (w/w) of tyrosine. In some embodiments, the processed fortified human milk product 175 includes 0.11%, 0.12%, 0.13%, 0.14%, 0.15%, 0.16%, 0.17%, 0.18%, 0.19%, 0.20%, 0.21%, 0.22%, 0.23%, or 0.24% (w/w) of tyrosine. In some embodiments, the processed fortified human milk product 175 includes between 0.90 and 1.05% (w/w) of valine. In some embodiments, the processed fortified human milk product 175 includes 0.91%, 0.92%, 0.93%, 0.94%, 0.95%, 0.96%, 0.97%, 0.98%, 0.99%, 1.00%, 1.01%, 1.02%, 1.03%, or 1.04% (w/w) of valine.

In various embodiments, the processed fortified human milk product 175 has a reduced amount of B. Cereus as compared to the amount of B. Cereus in the raw human breast milk 110 obtained from one or more human donors. In various embodiments, the reduction of B. Cereus is greater than a 1000 log reduction of levels of B. Cereus as compared to levels of B. Cereus in raw human breast milk 110.

In some embodiments, the concentration of total human milk oligosaccharides (HMOs) in the processed fortified human milk product 175 is between 6 g/L and 24 g/L. In some embodiments, the concentration of HMOs in the processed fortified human milk product 175 is between 12 g/L to 21 g/L. In some embodiments, the concentration of HMOs in the processed fortified human milk product 175 is between 15 g/L to 19 g/L. In some embodiments, the concentration of HMOs in the processed fortified human milk product 175 is 7 g/L, 8 g/L, 9 g/L, 10 g/L, 11 g/L, 12 g/L, 13 g/L, 14 g/L, 15 g/L, 16 g/L, 17 g/L, 18 g/L, 19 g/L, 20 g/L, 21 g/L, 22 g/L, 23 g/L, or 24 g/L.

In some embodiments, the concentration of fucosylated HMOs in the processed fortified human milk product 175 is between 6.0 g/L and 8 g/L. In some embodiments, the concentration of fucosylated HMOs in the processed fortified human milk product 175 is 6.1 g/L, 6.2 g/L, 6.3 g/L, 6.4 g/L, 6.5 g/L, 6.6 g/L, 6.7 g/L, 6.8 g/L, 6.9 g/L, 7.0 g/L, 7.1 g/L, 7.1 g/L, 7.2 g/L, 7.3 g/L, 7.4 g/L, 7.5 g/L, 7.6 g/L, 7.7 g/L, 7.8 g/L, or 7.9 g/L.

In some embodiments, the concentration of 2′-fucosyllactose in the processed fortified human milk product 175 is between 0.70 g/L and 4.3 g/L. In some embodiments, the concentration of 2′-fucosyllactose in the processed fortified human milk product 175 is between 1 g/L and 4 g/L. In some embodiments, the concentration of 2′-fucosyllactose in the processed fortified human milk product 175 is 0.7 g/L, 0.8 g/L, 0.9 g/L. 1.0 g/L, 1.1 g/L, 1.2 g/L, 1.3 g/L, 1.4 g/L, 1.5 g/L, 1.6 g/L, 1.7 g/L, 1.8 g/L, 1.9 g/L, 2.0 g/L, 2.1 g/L, 2.2 g/L, 2.3 g/L, 2.4 g/L, 2.5 g/L, 2.6 g/L, 2.7 g/L, 2.8 g/L, 2.9 g/L, 3.0 g/L, 3.1 g/L, 3.2 g/L, 3.3 g/L, 3.4 g/L, 3.5 g/L, 3.6 g/L, 3.7 g/L, 3.8 g/L, 3.9 g/L, or 4.0 g/L.

In some embodiments, the concentration of 3′-fucosyllactose in the processed fortified human milk product 175 is between 0.92 g/L and 1.1 g/L. In some embodiments, the concentration of 3′-fucosyllactose in the processed fortified human milk product 175 is between 0.93 g/L, 0.94 g/L, 0.95 g/L, 0.96 g/L, 0.97 g/L, 0.98 g/L, 0.99 g/L, 1.00 g/L, 1.01 g/L, 1.02 g/L, 1.03 g/L, 1.04 g/L, 1.05 g/L, 1.06 g/L, 1.07 g/L, 1.08 g/L, 1.09 g/L, or 1.10 g/L.

In some embodiments, the concentration of sialylated HMOs in the processed fortified human milk product 175 is between 1.70 g/L and 2.00 g/L. In some embodiments, the concentration of sialylated HMOs in the processed fortified human milk product 175 is between 1.80 g/L and 1.90 g/L. In some embodiments, the concentration of sialylated HMOs in the processed fortified human milk product 175 is 1.80 g/L, 1.81 g/L, 1.82 g/L, 1.83 g/L, 1.84 g/L, 1.85 g/L, 1.86 g/L, 1.87 g/L, 1.88 g/L, 1.89 g/L, or 1.90 g/L.

In some embodiments, the concentration of non-fucosylated HMOs in the processed fortified human milk product 175 is between 4.50 and 4.75 g/L. In some embodiments, the concentration of non-fucosylated HMOs in the processed fortified human milk product 175 is 4.51 g/L, 4.52 g/L, 4.53 g/L, 4.54 g/L, 4.55 g/L, 4.56 g/L, 4.57 g/L, 4.58 g/L, 4.59 g/L, 4.60 g/L, 4.61 g/L, 4.62 g/L, 4.63 g/L, 4.64 g/L, 4.65 g/L, 4.66 g/L, 4.67 g/L, 4.68 g/L, 4.69 g/L, 4.70 g/L, 4.71 g/L, 4.72 g/L, 4.73 g/L, or 4.74 g/L.

In typical NNU fortification embodiments, at least 95% by weight of the amino acids in the high NNU composition are free amino acids. In certain embodiments, at least 96%, 97%, 98%, even at least 99% of the amino acids in the high NNU composition are free amino acids. In typical embodiments, less than 5% by weight of the amino acids in the high NNU composition are incorporated into peptides. In certain embodiments, less than 4%, 3%, 2%, even less than 1% by weight of the amino acids are incorporated into peptides. In particular embodiments, the composition contains no detectable peptides.

In typical embodiments, the high NNU composition comprises isoleucine, leucine, lysine, methionine, phenylalanine, threonine, tryptophan, and valine, each as the L-isomer. In some embodiments, the high NNU composition further comprises L-histidine. In some embodiments, the high NNU composition further comprises one or more non-essential amino acids.

In typical embodiments, the amino acids are present in the ratios described in U.S. Pat. No. 5,132,113, which is incorporated herein by reference in its entirety. In certain of these embodiments, the amino acids are present in the following proportions, in grams per 10 grams composition:

(a) from 1.217 to 1.647 isoleucine;

(b) from 1.827 to 2.735 leucine;

(c) from 1.260 to 2.359 lysine;

(d) from 0.232 to 0.778 methionine;

(e) from 0.843 to 1.314 phenylalanine;

(f) from 0.970 to 1.287 threonine;

(g) from 0.208 to 0.467 tryptophan; and

(h) from 1.260 to 1.900 valine.

In certain embodiments, the amino acids are present in the proportions set forth in one of the eight compositions (I-VIII) in Table 1, in grams per 10 grams composition:

TABLE 1
Exemplary High NNU Protein Compositions

| | I | II | III | IV | V | VI | VII | VIII |
|---|---|---|---|---|---|---|---|---|
| isoleucine | 1.438 | 1.482 | 1.310 | 1.341 | 1.381 | 1.311 | 1.443 | 1.484 |
| leucine | 2.287 | 1.963 | 2.053 | 1.922 | 1.891 | 1.951 | 2.226 | 1.832 |
| lysine | 1.650 | 1.428 | 2.189 | 2.144 | 2.297 | 2.266 | 1.760 | 2.064 |
| methionine | 0.293 | 0.699 | 0.621 | 0.651 | 0.682 | 0.752 | 0.556 | 0.580 |
| phenyl- | 0.943 | 1.288 | 1.029 | 1.027 | 1.029 | 0.959 | 1.100 | 1.067 |
| alanine | | | | | | | | |
| threonine | 1.226 | 1.111 | 1.107 | 1.211 | 1.113 | 1.119 | 1.041 | 1.136 |
| tryptophan | 0.448 | 0.368 | 0.293 | 0.338 | 0.318 | 0.256 | 0.317 | 0.371 |
| valine | 1.721 | 1.656 | 1.390 | 1.358 | 1.284 | 1.376 | 1.553 | 1.461 |

In typical embodiments, the high NNU composition is added in an amount sufficient to ensure a protein concentration of the processed fortified milk product 175 (F=6.38) of at least 1.0 g/100 g (1.0 wt %), 1.1 wt %, 1.2 wt %, 1.3 wt %, or at least 1.4 wt %. In certain embodiments, the high NNU composition is added in an amount sufficient to ensure a protein concentration of the processed fortified milk product 175 of at least 1.30 wt %, 1.31 wt %, 1.32 wt %, 1.33 wt %, 1.34 wt %, 1.35 wt %, 1.36 wt %, 1.37 wt %, 1.38 wt %, 1.39 wt % or at least 1.40 wt %.

In some embodiments, the high NNU composition is added in an amount sufficient to ensure a protein concentration of the processed fortified milk product 175 of greater than 1.4 wt %. In certain of these high protein embodiments, the high NNU composition is added in an amount sufficient to ensure a protein concentration of the processed fortified milk product 175 of greater than 1.40 wt %, 1.41 wt %, 1.42 wt %, 1.43 wt %, 1.44 wt %, 1.45 wt %, 1.46 wt %, 1.47 wt %, 1.48 wt %, 1.49 wt %, even greater than 1.50 wt %. In certain of these high protein embodiments, the high NNU composition is added in an amount sufficient to ensure a protein concentration of the processed fortified milk product 175 of greater than 1.6 wt %, 1.7 wt %, 1.8 wt %, 1.9 wt %, or even greater than 2.0 wt %.

In various embodiments, the high NNU composition is added in an amount that provides at least 5% of the protein content of the processed fortified milk product 175. In certain embodiments, the high NNU composition is added in an amount that provides at least 6%, 7%, 8%, 9%, or at least 10% of the protein content of the processed fortified milk product 175. In particular embodiments, the high NNU composition is added in an amount that provides at least 15%, 20%, even at least 25% of the protein content of the processed fortified milk product 175. In certain embodiments, the high NNU composition is added in an amount that provides at least 30%, 35%, 40%, 45% or even at least 50% of the protein content of the processed fortified milk product 175.

In various embodiments, the high NNU composition is added in an amount that provides no more than 50% of the protein content of the processed fortified milk product 175. In specific embodiments, the high NNU composition is added in an amount that provides no more than 45%, 40%, 35%, 30%, or 25% of the protein content of the processed fortified milk product 175.

In a variety of embodiments, the high NNU composition is added in an amount that provides more than 50% of the protein content of the processed fortified milk product 175. These latter embodiments may be used alone, or in some embodiments will be mixed with non-fortified milk before administration. In certain of these embodiments, the high NNU composition is added in an amount that provides at least 50%, 55%, 60%, 65%, 70%, 75% even at least 80%, 85%, 90% or 95% of the processed fortified milk product 175.

### 7. EXAMPLES

The following examples are put forth so as to provide those of ordinary skill in the art with a complete disclosure and description of how to make and use the subject invention, and are not intended to limit the scope of what is regarded as the invention. Efforts have been made to ensure accuracy with respect to the numbers used (e.g. amounts, temperature, concentrations, etc.) but some experimental errors and deviations should be allowed for. Unless otherwise indicated, parts are parts by weight, molecular weight is average molecular weight, temperature is in degrees centigrade; and pressure is at or near atmospheric.

### 7.1. Example 1: UHT Sterilization of Non-Fortified Human Milk

Fourteen different UHT sterilization runs were performed on human milk obtained from human donors using an Ultra-High Temperature Lab-25 indirect steam high viscosity hybrid unit to perform ultra-high temperature sterilization using various sterilization parameters to obtain sterilized, non-fortified human milk.

The human milk was validated and pooled prior to sterilization.

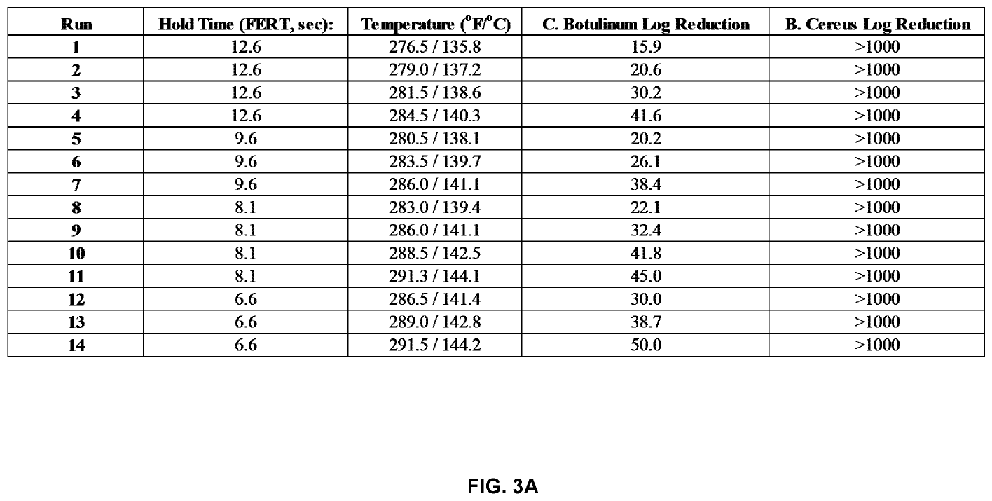

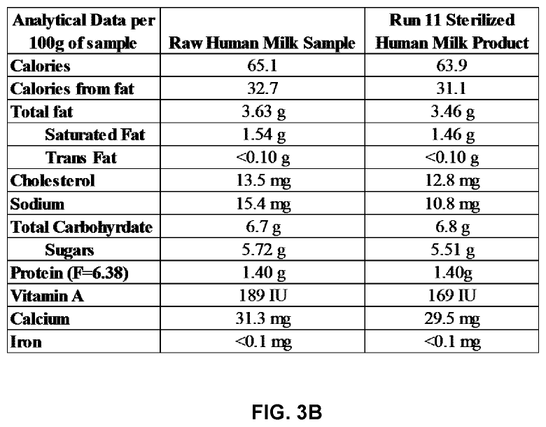

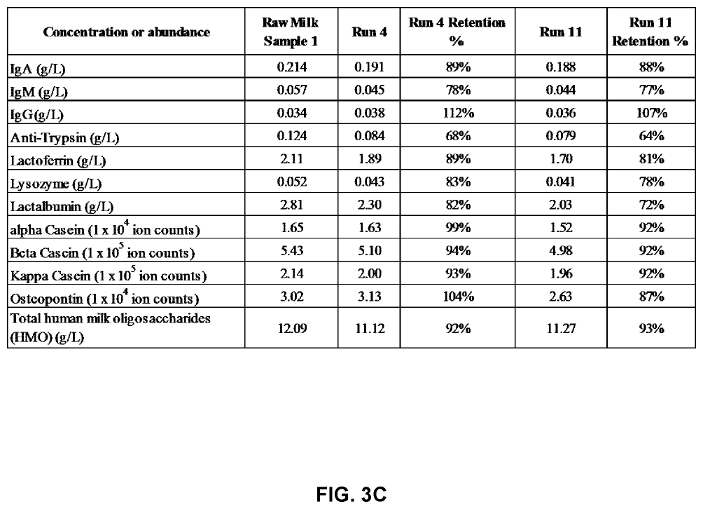

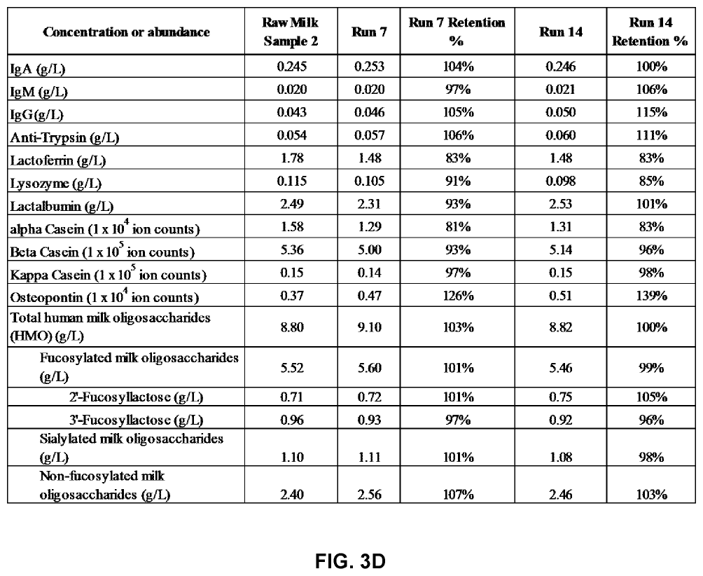

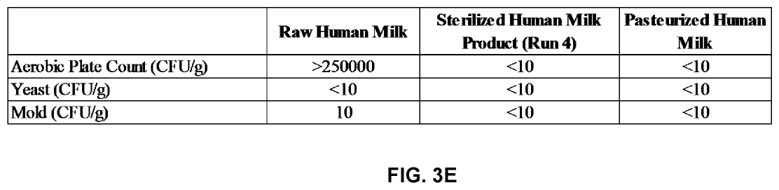

The human milk was heated to a target temperature while undergoing countercurrent heat exchange and held at the target temperature for a duration of time. FIG. 3A depicts the parameters (e.g., temperature and hold time) from various sterilization runs. Generally, hold times, recited in terms of fluid elements residence time (FERT), ranged from 6.6 seconds up to 12.6 seconds with a temperature range from 135° C. to 145° C. The FERT refers to the residence time of elements (e.g., milk) flowing through the center of the hold tube. A flow rate of 0.25 gallons/min of the human milk product was held constant across all runs. Additionally depicted in FIG. 3A is the log reduction of C. Botulinum and B. Cereus for each run. Generally, the data confirm between a 12-50 log reduction in C. Botulinum content and greater than 1000 log reduction of B. Cereus. This meets and exceeds the standard 12 log reduction (12 D concept) for sterilization of a given food.

Of note, an additional human milk sample underwent ultra-high temperature sterilization using the processing parameters shown for Run 8 (e.g., hold time=8.1 seconds, temperature=286° F./141.1° C.). Following sterilization, the additional sterilized human milk product also exhibited a greater than 1000 log reduction of B. Cereus.

Reference is now made to FIG. 3B, which depicts comparative nutritional data of a raw human milk sample and sterilized human milk product from Run 11, which included a hold time of 8.1 seconds and a target temperature of 144.1° C. As shown in FIG. 3B, for a 100 g sample, minimal differences were observed in vital nutritional components and properties—including total calories, total fat, cholesterol, sodium, carbohydrates, protein, vitamin A, vitamin C, calcium, iron, amino acids, vitamins—as compared to raw human milk. Namely, the majority of components (except for sodium) and properties of the sterilized human milk product exhibited a difference of 6 percent or less in comparison to the components and characteristics of the raw human milk sample.

The additional sterilized human milk product that underwent ultra-high temperature sterilization using the processing parameters of Run 8 (e.g., hold time=8.1 seconds, temperature=286° F./141.1° C.) was further analyzed for protein quality using the standardized Food and Agricultural Organization (FAO) method (e.g., FAO Paper 51 (1991)). The protein digestibility corrected amino acid score (PDCAAS) of this sterilized human milk product was 73.3 (w/w %).

Reference is now made to FIG. 3C, which depicts comparative concentrations and abundance of components measured by mass spectrometry in a first batch of raw human breast milk in comparison to sterilized human milk product for two of the experimental runs: Run 4 and Run 11. Each of the sterilized human milk product obtained from Runs 4 and 11 was derived from the first batch of raw human breast milk. The components quantified by mass spectrometry include immunoglobulins (IgA, IgM, and IgG), proteins (Anti-Trypsin, Lactoferrin, Lysozyme, Lactalbumin, alpha casein, beta casein, kappa casein, and osteopontin), and human milk oligosaccharides (HMOs). Further depicted in FIG. 3C is the retention percentage of each of the components in the standardized human milk product for each respective sterilization run.

Specifically, the Run 4 sterilization process resulted in retention percentages of a majority of components that are above 80%, aside from IgM (78% retention) and Anti-Trypsin (68% retention). Importantly, FIG. 3C includes concentration and retention numbers of total HMOs, a component of human milk that is often overlooked in sterilized human milk products. Here, the sterilized human milk product generated using the Run 4 sterilization process retains 92% of total HMOs. The Run 11 sterilization process retained 93% of total HMOs.

Reference is now made to FIG. 3D, which further depicts comparative concentrations and abundance of components measured by mass spectrometry in sterilized human milk products in comparison to a second raw milk batch. Specifically, FIG. 3D depicts sterilized milk products obtained as a result of Run 7 and Run 14, as shown in FIG. 3A. Each of the sterilized human milk product obtained from Runs 7 and 14 was derived from the second batch of raw human breast milk. Here, the measured components of the sterilized milk products include immunoglobulins (IgA, IgM, and IgG), proteins (Anti-Trypsin, Lactoferrin, Lysozyme, Lactalbumin, alpha casein, beta casein, kappa casein, and osteopontin), and human milk oligosaccharides (HMOs). Furthermore, the abundance of individual elements of the HMOs were further characterized, the individual elements including fucosylated HMOs, sialylated HMOs, and non-fucosylated HMOs. Additionally, the abundance of individual elements of fucosylated HMOs, including 2′-fucosyllactose (2-FL) and 3′-fucosyllactose (3-FL), were further quantified. Given that 2-FL and 3-FL have been implicated in protecting against infectious diseases and reducing inflammation, the retention of 2-FL and 3-FL through the sterilization process is of interest.

Here, the Run 7 and Run 14 sterilization processes each resulted in retention percentages of components above 80%, with the majority of components experiencing retention percentages above 90%. The retention percentages of some components are noted to exceed 100%, though these results may be a consequence of measurement error. Of note, the retention percentage of total HMOs for both Run 7 and Run 14 was near 100%. Similarly, the retention percentage of 2-FL and 3-FL for Run 7 and Run 14 were also each near 100%. This demonstrates that the sterilization process does not damage HMOs and, therefore, can ensure the bioavailability of important HMOs, such as 2-FL and 3-FL, that may have a therapeutic effect when consumed.

As shown in both FIG. 3C and FIG. 3D, the sterilization process achieves high retention percentages of components in the sterilized human milk product. Given that FIGS. 3C and 3D each recites a percentage retention for each component, the absolute concentration of each component in the sterilized human milk product will be dependent on the concentration of each component in the raw human breast milk when obtained from a donor. As shown by the first and second batches of raw human milk sample (e.g., FIGS. 3C and 3D) and further confirmed by prior literature, the concentrations of various components (e.g., the components depicted in FIGS. 3C and 3D) in raw human breast milk varies widely. For example, prior literature has shown that lactoferrin levels in breast milk differ as a function of time post-delivery (e.g., 1 day, 14 weeks, and 6 months). See Shashiraj, F. M. et al., European Journal of Clinical Nutrition 60:903-908 (2006). Additionally, levels of components in breast milk differs based on whether the birth was a preterm or full term birth. See Mehta, R. et al., Journal of Perinatology 31:58-62 (2011).

Specifically, the concentration of lactoferrin in raw human breast milk has been shown to range up to 14.92 g/L. See Turn, C. G. et al., Journal of Perinatology 37(5):507-512 (2017). Additionally, the concentration of lactoferrin in raw human breast milk has been shown to be as low as 1 g/L. See Montagne, P. et al., Advances in Experimental Medicine and Biology, vol 501, Springer, Boston, Mass. Therefore, given the 81% retention achieved in Run 11 (as depicted in FIG. 3C) of the sterilization process, the concentration of lactoferrin in a sterilized milk product can range from 0.81 g/L up to 13.28 g/L. Additionally, the lysozyme concentration in raw human breast milk can be 0.015 g/L. See Hsu, Y. et al., Pediatrics and Neonatology 55:449-454 (2014). Therefore, given the 91% retention achieved in Run 7 of the sterilization process, the concentration of lysozyme in a sterilized milk product can range from 0.012 g/L to 0.105 g/L (Run 7 of FIG. 3D). Additionally, the lactalbumin concentration in raw human breast milk can range from 2.28 g/L up to 3.27 g/L. See Affolter, M. et al., Nutrients 8(8):504 (2016). Therefore, given the 82% retention achieved in Run 4 of the sterilization process, the concentration of lactalbumin in a sterilized milk product can range from 1.87 g/L to 2.68 g/L. Additionally, the anti-trypsin concentration in raw human breast milk can range from 0.1 g/L to 0.4 g/L. See Chowanadisai, W. et al., Am. J. Clin. Nutr. 76(4):828-833 (2002). Therefore, given the near 100% retention of anti-trypsin achieved in Run 7 and Run 11, the concentration of anti-trypsin in a sterilized milk product can range from 0.057 (Run 7) up to 0.4 g/L.

Additionally, the human milk oligosaccharide concentration in human breast milk can range up to 20 g/L. See Gabrielli, O. et al., Pediatrics, 128(6):e1520-31 (2011). FIG. 3C depicts a raw milk sample with 12 g/L of human milk oligosaccharides whereas FIG. 3D depicts a raw milk sample with 8.8 g/L of human milk oligosaccharides. Therefore, the concentration of HMOs in a sterilized milk product can range from 8.8 g/L (see Run 14) up to 20 g/L, given the near 100% retention observed in Run 7 and 14. Additionally, the 2′fucosyllactose concentration in human breast milk can range from 1.1 to 4.3 g/L. See Puccio, J. Pediatr. Gastroenterol. Nutr. 64(4): 624-631 (2017). Therefore, given the near 100% retention achieved in Run 7 and Run 14, the concentration of 2′fucosyllactose in a sterilized milk product can range from 0.72 g/L (Run 7) to 4.3 g/L.

FIG. 3E depicts quantified bacterial, mold and yeast content for raw human milk, sterilized human milk product, and pasteurized human milk. Here, the sterilized human milk product corresponds to Run 4 of the sterilization process as described above. The raw human milk corresponds to the same sample prior to sterilization. Pasteurized human milk was obtained from Mother's Milk Bank (San Jose, Calif.), which was processed using Holder pasteurization (e.g., 62.5° C. for 30 minutes).

A standard aerobic plate count of each sample was performed to determine the level of microorganisms in the sample. Serial dilutions of each sample were plated on an agar petri dish and incubated (48 hours at 37° C.) to allow for microorganism colony formation. Colony forming units (CFUs) of each serial dilution were visualized and quantified to determine the aerobic plate count of each petri dish sample. Specifically, the sterilized human milk product demonstrated significantly lower pathogen counts (<10 CFUs per gram) in comparison to the raw human milk (>250,000 CFUs per gram). Similarly, pasteurized human milk demonstrated significantly lower pathogen counts (<10 CFUs per gram) in comparison to the raw human milk.

### 7.2. Example 2: UHT Sterilization of Fortified Human Milk

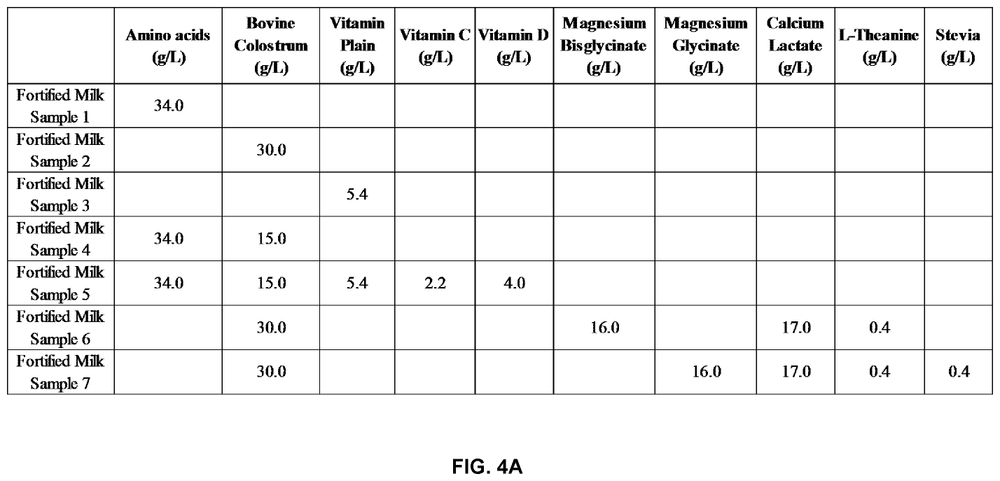

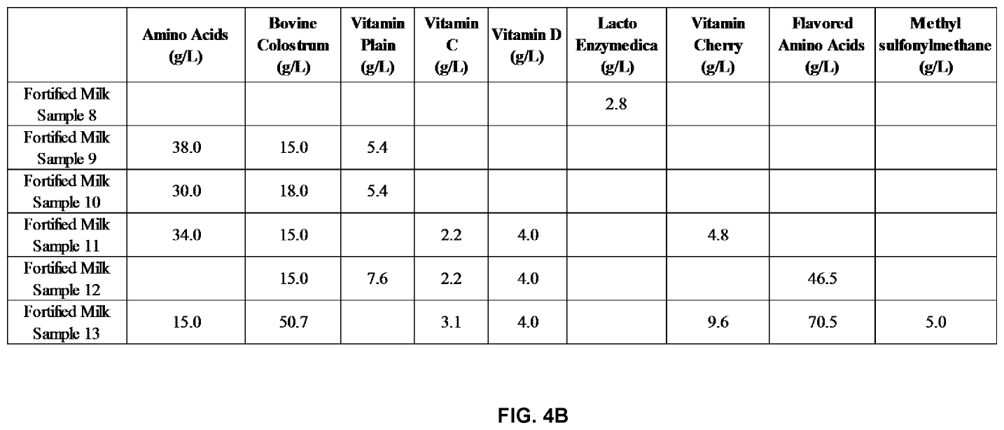

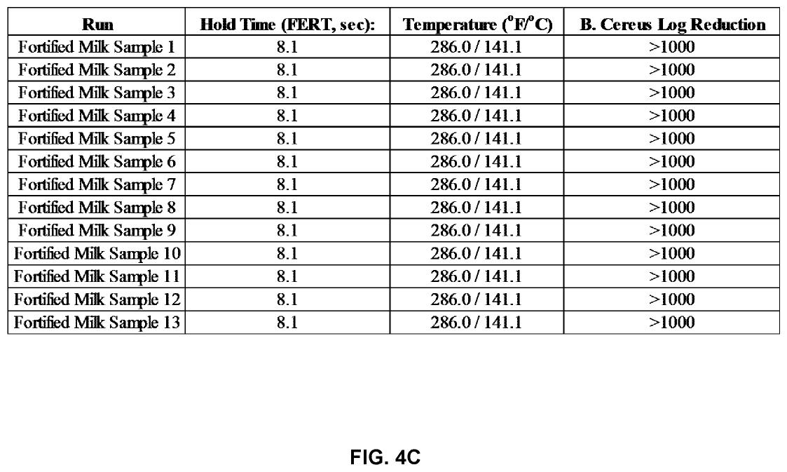

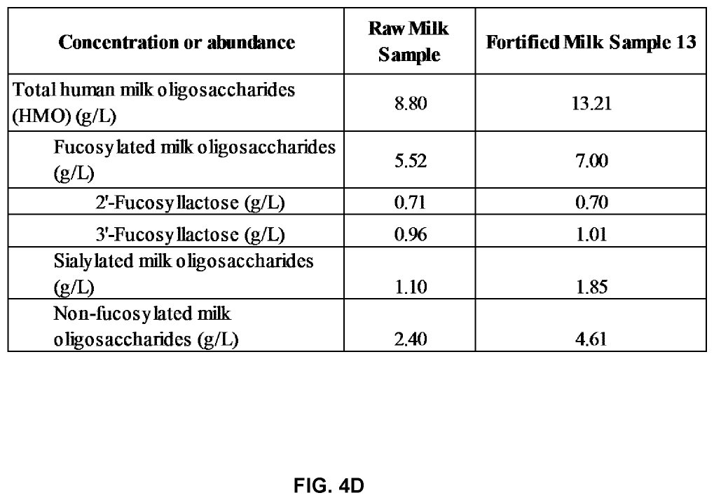

Human milk was obtained from human donors, validated, and pooled. The pooled human milk was divided into thirteen batches and each batch was fortified with one or more supplements. Supplements include amino acids, bovine colostrum, vitamin plain, vitamin C, vitamin D, magnesium bisglycinate, magnesium glycinate, calcium lactate, L-theanine, stevia, lacto enzymedica, vitamin cherry, flavored amino acids, and methylsulfonylmethane. Reference is made to FIGS. 4A and 4B, which presents the formulation of each fortified milk sample. Specifically, FIGS. 4A and 4B present the amount of each supplement, in grams, that was added to each liter of human milk to obtain each fortified milk sample.

Each fortified milk sample underwent ultra-high temperature sterilization using an Ultra-High Temperature Lab-25 electric high viscosity hybrid unit. Reference is made to FIG. 4C, which presents the processing parameters used to sterilize each fortified milk sample. Specifically, each fortified human milk sample was heated to a target temperature of 286° F./141.1° C. while undergoing countercurrent heat exchange and held at the target temperature for 8.1 seconds. A flow rate of 0.25 gallons/min of each fortified human milk product was held constant across all runs.

Additionally depicted in FIG. 4C is the log reduction of B. Cereus for each run. For each sterilized fortified milk sample, a greater than 1000 log reduction of B. Cereus was observed in comparison to the corresponding raw fortified milk sample counterpart.

FIG. 4D presents compositional characteristics of a raw milk sample and sample 13 of the sterilized fortified human milk product which is fortified with nutrients as shown in FIG. 4B. Specifically, FIG. 4D presents concentrations of human milk oligosaccharides (HMOs) in the raw milk sample and the fortified milk sample 13. Given the fortification of nutrients, the fortified milk sample 13 exhibits higher concentrations of milk oligosaccharides in comparison to the raw milk sample. Specifically, the fortified milk sample 13 exhibited higher total HMOs (13.21 g/L vs 8.8 g/L), fucosylated milk oligosaccharides (7.0 g/L vs 5.52 g/L), sialylated milk oligosaccharides (1.85 g/L vs 1.10 g/L) and non-fucosylated milk oligosaccharides (4.61 g/L vs 2.40 g/L). Additionally, the fortified milk sample 13 exhibited similar levels of 2′-fucosyllactose (˜0.70 g/L) and 3′-fucosyllactose (˜1.01 g/L) in comparison to the raw milk sample.

The human milk oligosaccharide concentration in human breast milk can range up to 20 g/L. See Gabrielli, O. et al., Pediatrics, 128(6):e1520-31 (2011). FIG. 4D depicts a raw milk sample with 8.8 g/L of human milk oligosaccharides and a fortified milk sample 13 that has a concentration of 13.21 g/L of human milk oligosaccharides. Given that the fortified milk sample 13 was fortified from the raw milk sample, the difference of ˜4.4 g/L of human milk oligosaccharides can arise from the fortification process. Therefore, assuming an initial HMO concentration of 20 g/L in a raw milk sample, a fortified milk sample can have up to ˜24 g/L of HMO. Thus, the concentration of HMOs in a sterilized fortified milk product can range from 13 g/L (see fortified milk sample 13) up to 24 g/L.

Additionally, the 2′fucosyllactose concentration in human breast milk can range from 1.1 to 4.3 g/L. See Puccio, J. Pediatr. Gastroenterol. Nutr. 64(4): 624-631 (2017). Therefore, the concentration of 2′fucosyllactose in a sterilized fortified milk product can range from 0.70 g/L (fortified milk sample 13) to 4.3 g/L.

### 7.3. Example 3: Commercial-Scale UHT Sterilization of Non-Fortified Human Milk and Fortified Human Milk

Commercial scale UHT sterilization of a non-fortified batch of human milk and a fortified batch of human milk were performed.

Referring to the non-fortified batch of human milk, ultra-high temperature sterilization of the commercial-scale batch of non-fortified batch of human milk was performed. A total of 50,000 fluid ounces (˜1480 liters) of human milk from various human donors were validated and pooled prior to sterilization. The pooled 50,000 fluid ounces of human milk was sterilized using the Tetra Therm® Aseptic Flex to provide an ultra-high temperature treatment at the Tetra Pak Pilot Plant (Denton, Tex.), which is an FDA-registered food production facility.

The 50,000 fluid ounces of human milk was heated to a target temperature of 289.4° F./143° C. while undergoing countercurrent heat exchange and held at the target temperature for 10.3 seconds. The human milk was flowed through the sterilization system at a flow rate of 8 gallons/min. Following sterilization of the human milk, the sterilized milk product underwent in-line homogenization at 1800-2500 psi. The homogenized sterilized milk product was then aseptically bottled into 330 mL bottles.

Referring to the fortified batch of human milk, a total of 27,000 fluid ounces (800 liters) of human milk from various human donors were validated, pooled, and fortified prior to ultra-high temperature sterilization. Specifically, the human milk was fortified with bovine colostrum (50.7 g per liter of human milk), amino acids (70.5 g per liter of human milk), ascorbic acid (3.1 g per liter of human milk), and vitamin D (4.0 g per liter of human milk). Organic stevia extract was also added. The 27,000 fluid ounces of fortified human milk was sterilized using the Tetra Therm® Aseptic Flex to provide an ultra-high temperature treatment at the Tetra Pak Pilot Plant (Denton, Tex.), which is an FDA-registered food production facility.

The 27,000 fluid ounces of fortified human milk was heated to a target temperature of 289.4° F./143° C. while undergoing countercurrent heat exchange and held at the target temperature for 10.3 seconds. The fortified human milk was flowed through the sterilization system at a flow rate of 8 gallons/min. Following sterilization of the fortified human milk, the sterilized fortified milk product underwent in-line homogenization at 1800-2500 psi. The sterilized fortified milk product was then obtained and aseptically bottled into 330 mL bottles.

Bottles of sterilized, non-fortified and sterilized fortified human milk product was provided to Merieux Nutrisciences (Crete, Ill.) for determination of the composition of the each sterilized human milk product. Specifically, the sampled sterilized human milk product was tested for the following characteristics and components: density (g/mL), calories (g), total fat (g), monounsaturated fat (g), polyunsaturated fat (g), saturated fat (g), trans fat (g), cholesterol (mg), sodium (g), potassium (mg), total carbohydrates (g), sugars (g), fructose (g), glucose (g), lactose (g), maltose (g), sucrose (g), galactose (g), protein (g), calcium (mg), iron (mg), moisture (g), ash (g), vitamin D2 (mcg) and vitamin D3 (mcg). Additionally, the sterilized human milk products (both fortified and non-fortified) were further tested for protein quality which is quantified using the protein digestibility corrected amino acid score (PDCAAS) or the amino acid score. Furthermore, the sterilized human milk products (both fortified and non-fortified) were tested for specific amino acids.

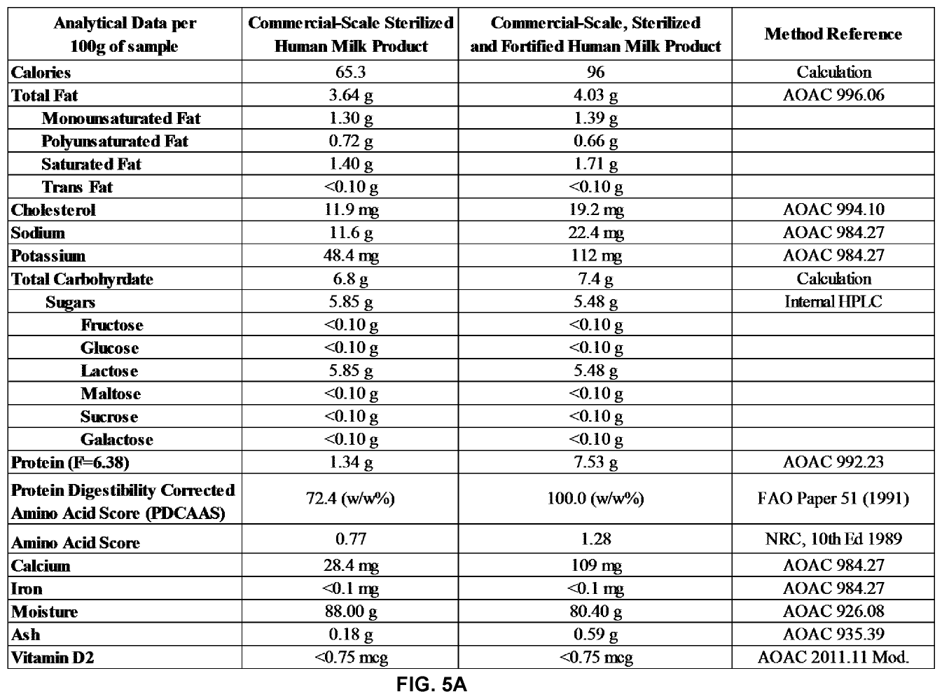

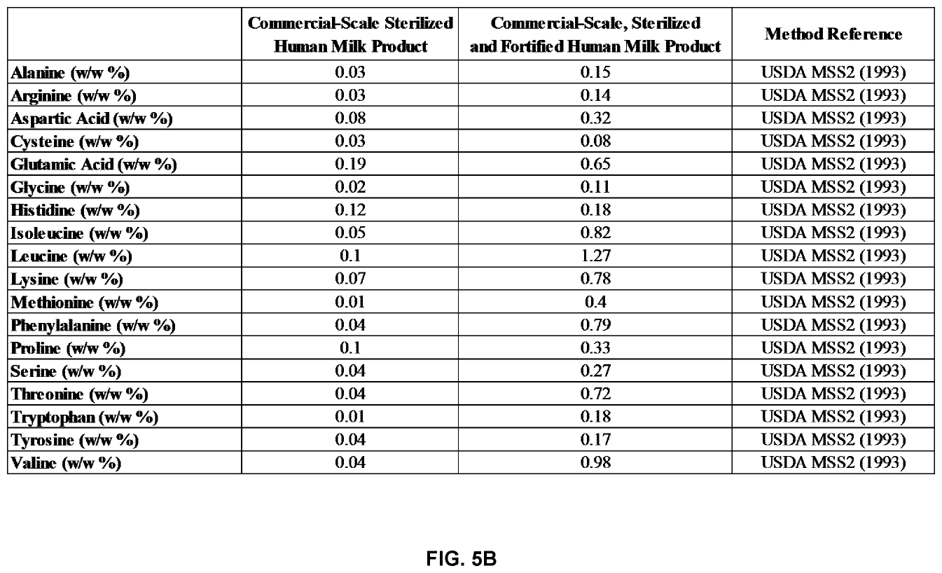

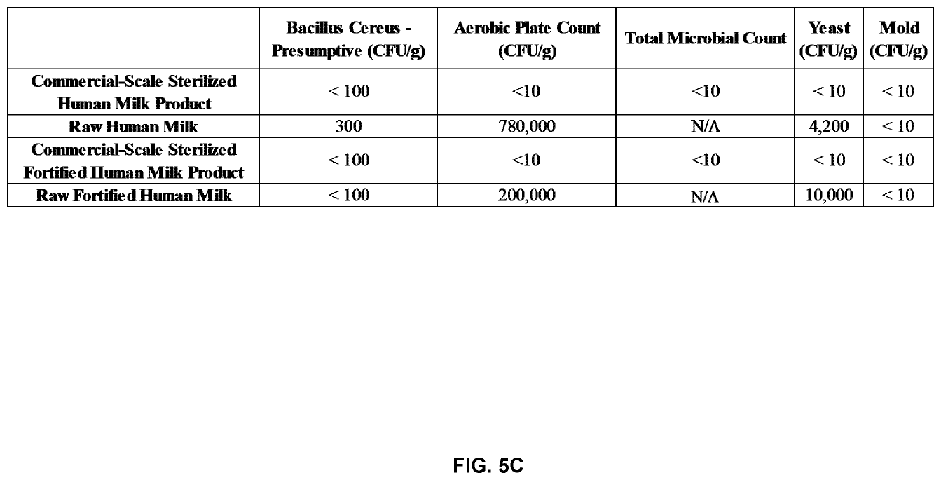

FIG. 5A presents the analytical data. Additionally, FIG. 5A identifies the method reference used to determine various corresponding analytical components. Components were detected using official Association of Official Agricultural Chemists (AOAC) methods, Food and Agricultural Organization (FAO) methods, internal high performance liquid chromatography, or database calculations. The density of the sample of sterilized, non-fortified human milk product was 1.016 g/mL whereas the density of the sample of sterilized fortified human milk product was 1.052 g/mL. Of note, the sterilized, non-fortified milk product had a protein digestibility corrected amino acid score (PDCAAS) of 72.4 (w/w %) and an amino acid score of 0.77. The PDCAAS of the sterilized fortified milk product was 100.0 (w/w %), which indicates the added protein of the sterilized fortified milk product due to the fortification process. Additionally, the amino acid score of sterilized fortified milk was 1.28, indicating the high quality of protein. Although not shown in FIG. 5A, a pasteurized human milk sample obtained from the Mothers Milk Bank in San Jose, Calif., which had previously undergone conventional pasteurization treatment at 145° F./62.8° C. for 30 minutes, had a PDCAAS of 64.9 (w/w %) and an amino acid score of 0.69.

FIG. 5B presents concentrations (w/w %) of different amino acids in sterilized, non-fortified and sterilized fortified human milk products. Given the fortification of nutrients in the sterilized fortified human milk product, the concentration of amino acids in the sterilized fortified human milk product is significantly higher than the concentration of amino acids in the sterilized, non-fortified human milk product.

Bottles of sterilized, non-fortified and sterilized fortified human milk product were also provided to Merieux NutriSciences (Salida, Calif.) for the determination of B. Cereus, aerobic plate count, total microbial count, yeast, and mold in the aseptically bottled, sterilized human milk product. Reference is now made to FIG. 5C, which depicts microbial counts from sterilized, non-fortified human milk product and sterilized fortified human milk product in comparison to their raw counterparts. B. Cereus counts were determined using the standardized AOAC 980.31 method for determining B. Cereus in foods. Aerobic plate count of each sample was determined using the standardized AOAC 966.23 method. Total microbial count was determined using the standardized USP<61> test for total aerobic microbial count. Yeast and mold were determined using the standardized USP <61> test for Microbiological Examination of Non-sterile Products.

The sterilized, non-fortified human milk product exhibited low levels (<100 CFU/g) of presumptive B. Cereus in comparison to a raw human milk sample, which exhibited significantly higher levels (300 CFU/g) of presumptive B. Cereus. Both the sterilized fortified human milk product and the raw fortified human milk exhibited low levels (<100 CFU/g) of presumptive B. Cereus.

The sterilized, non-fortified human milk product exhibited a low (<10 CFU/g) aerobic plate count, low total microbial count (<10 CFU/g), low levels of yeast (<10 CFU/g), and low levels of mold (<10 CFU/g). On the contrary, raw human milk sample exhibited a significantly higher (780,000 CFU/g) aerobic plate count and high levels of yeast (4,200 CFU/g). Similarly, the sterilized fortified human milk product exhibited a low (<10 CFU/g) aerobic plate count, low total microbial count (<10 CFU/g), low levels of yeast (<10 CFU/g), and low levels of mold (<10 CFU/g). On the contrary, raw fortified human milk sample exhibited a significantly higher aerobic plate count (200,000 CFU/g) and high levels of yeast (10,000 CFU/g).

### 7.4. Example 4: Fortification of Human Milk with High Net Nitrogen Utilization Protein

Human milk is obtained from human donors, validated, and pooled. The pooled human milk is fortified with high net nitrogen utilization (NNU) protein. Specifically, the human milk is fortified with crystalline amino acid solution to achieve desired levels of high NNU. Table 2 shows the final composition of the high NNU composition which includes the following concentrations of amino acids per 10 grams of the high NNU composition.

TABLE 2
High NNU Composition

| | |
|---|---|
| isoleucine | 1.40 |
| leucine | 2.02 |
| lysine | 1.97 |
| methionine | 0.60 |
| phenylalanine | 1.06 |
| threonine | 1.13 |
| tryptophan | 0.34 |
| valine | 1.47 |

### 7.5. Example 5: LTLT Pasteurization of Fortified Human Milk

A fortified batch of human milk is placed in a vat and heated to a target temperature for a target hold time to perform LTLT pasteurization on the fortified batch of human milk. Here, the vat is the Vat/Batch Pasteurizer by C. Van 't Riet/Dairy Technology USA. Specifically, LTLT pasteurization is performed by raising the fortified batch of human milk in the vat to a target temperature of 62.5° C. The fortified batch of human milk is continuously stirred while the temperature is raised to 62.5° C. Once the temperature of the fortified batch of human milk arrives at the target temperature 62.5° C., the temperature of the fortified batch of human milk is held for a target hold time of 30 minutes. After 30 minutes elapse, the fortified batch of human milk is cooled to room temperature. Here, the cooled milk batch represents the processed fortified human milk. The processed fortified human milk is aseptically bottled.

### 7.6. Example 6: HTST Pasteurization of Fortified Human Milk

A fortified batch of human milk is placed in a container and heated to a target temperature for a target hold time to perform HTST pasteurization on the fortified batch of human milk. Here, the container is included as a part of the GEA compact milk pasteurizer MWA. Specifically, HTST pasteurization is performed by raising the fortified batch of human milk in the vat to a target temperature of 71° C. The fortified batch of human milk is continuously stirred while the temperature is raised to 71° C. Once the temperature of the fortified batch of human milk arrives at the target temperature 71° C., the temperature of the fortified batch of human milk is held for a target hold time of 15 seconds. After 15 seconds elapses, the fortified batch of human milk is cooled to room temperature. Here, the cooled milk batch represents the processed fortified human milk. The processed fortified human milk is aseptically bottled.

### 7.7. Example 7: Thermization Processing of Fortified Human Milk

A fortified batch of human milk is placed in a container and heated to a target temperature for a target hold time to perform thermization sanitation on the fortified batch of human milk. Specifically, thermization sanitation is performed by raising the fortified batch of human milk in the container to a target temperature of 64° C. The fortified batch of human milk is continuously stirred while the temperature is raised to 64° C. Once the temperature of the fortified batch of human milk arrives at the target temperature 64° C., the temperature of the fortified batch of human milk is held for a target hold time of 15 seconds. After 15 seconds elapses, the fortified batch of human milk is cooled to room temperature. Here, the cooled milk batch represents the processed fortified human milk. The processed fortified human milk is aseptically bottled.

### 7.8. Example 8: In-Container Sterilization of Fortified Human Milk

Fortified batches of human milk are packaged in a retortable glass container. Each retortable glass container that includes a batch of the fortified human milk is heated to a target temperature for a target hold time to perform in-container sterilization on the fortified human milk. Here, the Allpax 1300 Shaka retort is used to perform the in-container sterilization process. Specifically, in-container sterilization is performed by exposing the retortable container including the fortified batch of human milk to a target temperature of 120° C. Once the temperature of the fortified batch of human milk arrives at the target temperature 120° C., the temperature of the fortified batch of human milk is held for a target hold time of 5 minutes. After 5 minutes elapses, the retortable containers including the fortified batch of human milk is cooled to room temperature. Here, the milk within the retortable container represents sterilized fortified human milk.

### 7.9. Example 9: Irradiation Treatment of Fortified Human Milk

Fortified batches of human milk are packaged in a polystyrene container. Each polystyrene container that includes a batch of the fortified human milk is exposed to a specified dose of radiation for a target amount of time. Specifically, irradiation of the fortified human milk is performed by exposing the polystyrene container holding the fortified human milk to a 10 kilograys of electron beam for 1 minute. After 1 minute, the electron beam is turned off and the milk within the polystyrene container represents processed fortified human milk.

### 7.10. Example 10: Microwave Treatment of Fortified Human Milk

Fortified batches of human milk are packaged in a polyethylene tray container to facilitate microwave treatment. Each polyethylene tray container that includes a batch of the fortified human milk is exposed microwaves for a target amount of time. Specifically, microwaves at a frequency of 915 MHz is provided to the fortified human milk 8 minutes. After 8 minutes of microwave treatment, the milk within the polyethylene tray container represents processed fortified human milk.

What is claimed is:

1. A processed fortified human milk product, the product having, per 100 g: (a) 80 to 120 calories, (b) 3.0 g to 5.0 g of total fat, (c) 1.1 g to 2.3 g of saturated fat, (d) 14 mg to 22 mg of cholesterol, (e) 17 mg to 26 mg of sodium, (f) 3 g to 13 g of carbohydrates, (g) 2 g to 9 g of sugar, (h) 99 mg to 121 mg of calcium, and (i) 5.9 to 9.1 g of protein.

2. The processed fortified human milk product of claim 1, wherein the protein of the product comprises, per 100 g: (a) 0.1 g to 0.2 g of alanine, (b) 0.08 g to 0.2 g of arginine, (c) 0.26 to 0.38 g of aspartic acid, (d) 0.04 to 0.12 g of cysteine, (e) 0.60 to 0.70 g of glutamic acid, (f) 0.05 g to 0.15 g of glycine, (g) 0.13 g to 0.23 g of histidine, (h) 0.75 g to 0.90 g of isoleucine, (i) 1.20 g to 1.35 g of leucine, (j) 0.70 g to 0.85 g of lysine, (k) 0.35 to 0.45 g of methionine, (l) 0.25 g to 0.40 g of proline, (m) 0.20 g to 0.35 g of serine, (,) 0.64 to 0.80 g of threonine, (o) 0.10 g to 0.25 g of tryptophan, (p) 0.10 g to 0.25 g of tyrosine, and (q) 0.90 g to 1.05 g of valine.

3. The processed fortified human milk product of claim 1 or 2, the product having a protein digestibility corrected amino acid score greater than 65%.

4. The processed fortified human milk product of any one of claims 1-3, the product having an amino acid score greater than 0.70.

5. The processed fortified human milk product of any one of claims 1-4, wherein the carbohydrate of the product comprises a concentration of human milk oligosaccharides between 6 grams per liter and 24 grams per liter of the processed fortified human milk product.

6. The processed fortified human milk product of any one of claims 1-5, wherein the carbohydrate of the product comprises a concentration of fucosylated human milk oligosaccharides between 6.0 grams per liter and 8.0 grams per liter of the processed fortified human milk product.

7. The processed fortified human milk product of any one of claims 1-6, wherein the carbohydrate of the product comprises a concentration of 2′-fucosyllactose between 0.70 grams per liter and 4.3 grams per liter of the processed fortified human milk product.

8. The processed fortified human milk product of any one of claims 1-7, wherein the carbohydrate comprises a concentration of 3′-fucosyllactose between 0.92 grams per liter and 1.1 grams per liter of the processed fortified human milk product.

9. The processed fortified human milk product of any one of claims 1-8, wherein the carbohydrate comprises a concentration of sialylated human milk oligosaccharides between 1.80 grams per liter and 1.90 grams per liter of the processed fortified human milk product.

10. The processed fortified human milk product of any one of claims 1-9, wherein the carbohydrate comprises a concentration of non-fucosylated human milk oligosaccharides between 4.50 grams per liter and 4.75 grams per liter of the processed fortified human milk product.

11. The processed fortified human milk product of any one of claims 1-10, wherein the product has a bacterial aerobic plate count of less than 10 CFUs per gram of the processed fortified human milk product.

12. The processed fortified human milk product of any one of claims 1-11, wherein the product has a yeast count of less than 10 CFUs per gram of the processed fortified human milk product.

13. The processed fortified human milk product of any one of claims 1-12, wherein the product has a mold count of less than 10 CFUs per gram of the processed fortified human milk product.

14. The processed fortified human milk product of any one of claims 1-13, wherein the product has a presumptive Bacillus Cereus count of less than 100 CFUs per gram of the processed human milk product.

15. An aseptically packaged product comprising the processed human milk product of any one of claims 1-14.

16. The aseptically packaged product of claim 15, wherein the aseptically packaged product is packaged in one of a bottle, booster cup, paper carton, paper brick, or a pouch.

17. The processed fortified human milk product of any one of claims 1-14 or the aseptically packaged product of claim 15 or 16, wherein the processed fortified human milk product was processed using a low temperature long time pasteurization technique which comprises heating a fortified human milk sample to a target temperature of at least 62° C. and holding the fortified human milk sample at the target temperature for not less than 30 minutes.

18. The processed fortified human milk product of any one of claims 1-14 or the aseptically packaged product of claim 15 or 16, wherein the processed fortified human milk product was processed using a high temperature short time pasteurization technique which comprises heating a fortified human milk sample to a target temperature of at least 72° C. and holding the fortified human milk sample at the target temperature for not less than 15 seconds.

19. The processed fortified human milk product of any one of claims 1-14 or the aseptically packaged product of claim 15 or 16, wherein the processed fortified human milk product was processed using a retort processing technique which comprises heating a fortified human milk sample to a target temperature between 110° C. and 130° C. and holding the fortified human milk sample at the target temperature between 3 minutes to 30 minutes.

20. The processed fortified human milk product of any one of claims 1-14 or the aseptically packaged product of claim 15 or 16, wherein the processed fortified human milk product was processed using a thermization process which comprises heating a fortified human milk sample to a target temperature between 63° C. and 65° C. and holding the fortified human milk sample at the target temperature for not less than 15 seconds.

21. The processed fortified human milk product of any one of claims 1-14 or the aseptically packaged product of claim 15 or 16, wherein the processed fortified human milk product was processed using an irradiation treatment which comprises applying an ionizing radiation selected from one of gamma rays, x-rays, or electron beams.

22. The processed fortified human milk product or aseptically packaged product of claim 21, wherein the ionizing radiation was provided at a dose of 1 to 70 kilograys for a duration of time between 1 second and 45 minutes.

23. The processed fortified human milk product of any one of claims 1-14 or the aseptically packaged product of claim 15 or 16, wherein the processed fortified human milk product was processed using a microwave treatment which comprises applying microwaves to heat a fortified human milk sample to a target temperature between 70° C. and 130° C. for a pre-designated amount of time between 1 and 20 minutes.

24. The processed fortified human milk product or aseptically packaged product of claim 23, wherein the microwaves are applied at a frequency between one of 900 and 1000 MHz or 2100 and 2600 MHz.

25. The processed fortified human milk product of any one of claims 1-14 or the aseptically packaged product of claim 15 or 16, wherein the processed fortified human milk product was processed using an ultra-high temperature sterilization technique which comprises heating a fortified human milk sample to a target temperature between 130° C. and 150° C. and holding the fortified human milk sample at the target temperature for 2 to 20 seconds.

26. The processed fortified human milk product of claim 25, wherein heating the fortified human milk sample to a target temperature between 130° C. and 150° C. comprises providing heated steam into the fortified human milk sample.

27. The processed fortified human milk product of claim 26, wherein heating the fortified human milk sample to a target temperature between 130° C. and 150° C. comprises performing a counter-current heat exchange between the fortified human milk sample and a heating medium.

28. A method of producing a processed fortified human milk product, the method comprising:
receiving raw human milk obtained from one or more human donors;
fortifying the raw human milk with supplemental nutrients to achieve one of a target characteristic of the fortified raw human milk or a target concentration of a component in the fortified raw human milk; and
processing the fortified raw human milk by treating the fortified raw human milk to eliminate pathogens from the fortified raw human milk.

29. The method of claim 28, wherein processing the fortified raw human milk comprises performing an ultra-high temperature sterilization process on the fortified raw human milk, wherein treating the fortified raw human milk comprises raising a temperature of the fortified raw human milk to a target temperature between 130° C. and 150° C. and holding the fortified raw human milk for a hold time between 6 and 14 seconds.

30. The method of claim 28, wherein processing the fortified raw human milk comprises performing a low temperature long time pasteurization process on the fortified raw human milk, wherein treating the fortified raw human milk comprises raising a temperature of the fortified raw human milk to a target temperature between 162° C. and 64.5° C. and holding the fortified raw human milk for a hold time for at least 30 minutes.

31. The method of claim 28, wherein processing the fortified raw human milk comprises performing a high temperature short time pasteurization process on the fortified raw human milk, wherein treating the fortified raw human milk comprises raising a temperature of the fortified raw human milk to a target temperature of at least 71° C. and holding the fortified raw human milk for a hold time for at least 15 seconds.

32. The method of claim 28, wherein processing the fortified raw human milk comprises performing a thermization sanitation process on the fortified raw human milk, wherein treating the fortified raw human milk comprises raising a temperature of the fortified raw human milk to a target temperature of at least 63° C. and 65° C. and holding the fortified raw human milk for a hold time for at least 15 seconds.

33. The method of claim 28, wherein processing the fortified raw human milk comprises performing an irradiation treatment on the fortified raw human milk, wherein treating the fortified raw human milk comprises applying an ionizing radiation selected from one of gamma rays, x-rays, or electron beams at a dose of 1 to 70 kilograys for a duration of time between 1 second and 45 minutes.

34. The method of claim 28, wherein processing the fortified raw human milk comprises performing a microwave treatment on the fortified raw human milk, wherein treating the fortified raw human milk comprises raising a temperature of the fortified raw human milk to a target temperature of at least 70° C. and 130° C. for a pre-designated amount of time between 1 and 20 minutes.

35. The method of claim 34, wherein treating the fortified raw human milk comprises applying microwaves at a frequency between one of 900 and 1000 MHz or 2100 and 2600 MHz.

36. The method of claim 28, wherein processing the fortified raw human milk further comprises:
packaging the fortified raw human milk in a retortable container;
performing an in-container sterilization process on the packaged fortified raw human milk, wherein the target temperature is between 110° C. and 130° C. and wherein the target hold time is between 10 minutes and 30 minutes.

37. The method of any one of claims 28-36, wherein the supplemental nutrients is one or more of fat, protein, vitamins, cholesterol, ionic salts, carbohydrates, immunoglobulins, and oligosaccharides.

38. The method of any one of claims 28-37, wherein the target characteristic of the fortified raw human milk is one of a density or caloric content.

39. The method of any one of claims 28-38, further comprising:
prior to fortifying the raw human milk, eliminating pathogens from the raw milk by performing one or more clarification processes to obtain a clarified human milk sample.

40. The method of claim 39, further comprising, after eliminating pathogens through one or more clarification processes and prior to fortifying the raw human milk, steps of:
separating the clarified human milk sample into a cream sample and a skim sample;
generating a retentate by performing a concentration process on the skim sample; and
engineering a standardized human milk sample by combining a portion of the cream sample with a portion of the obtained retentate.

41. The method of claim 28, further comprising a step of, subsequent to processing the fortified raw human milk, packaging, through an aseptic process, the processed fortified human milk to produce the processed fortified human milk product.

42. The method of claim 41, wherein the processed fortified human milk is packaged in one of a bottle, booster cup, paper carton, paper brick, or a pouch
